(19) United States
(12) Patent Application Publication
(10) Pub. No.: US 2024/0082845 A1
(43) Pub. Date: Mar. 14, 2024

(54) Magnetic Particle Separation Device Actuation System and Negative Pressure Filling

(71) Applicant: Abbott Diagnostics Scarborough, Inc., Scarborough, ME (US)

(72) Inventors: Austin M. Derfus, Solana Beach, CA (US); Adrian P. Crute, Escondido, CA (US); Neil A. Quitoviera, Temecula, CA (US); Carl G. Santavicca, Poway, CA (US); Timothy L. Higby, Temecula, CA (US); Karthikeyan Kumaravadivelu, San Diego, CA (US); Armando R. Tovar, San Diego, CA (US); Darren S. Gray, San Diego, CA (US); Torsten Gliewe, San Diego, CA (US)

(21) Appl. No.: 18/274,395

(22) PCT Filed: Jan. 28, 2022
(86) PCT No.: PCT/US2022/014382

§ 371 Date: Jul. 26, 2023

Related U.S. Application Data
(60) Provisional application No. 63/143,587, filed on Jan. 29, 2021.

(51) Int. Cl. B01L 3/00

(52) U.S. Cl. CPC B01L 3/52; B01L 2200/0689; B01L 2300/042; B01L 2300/0832

(57) ABSTRACT

Aspects of the present disclosure include a system for transporting a liquid from a chamber into one or more collection containers. The system may be semi-automatic or fully automatic. The system may be embodied in a sample preparation device, such as a cylindrical cartridge. The system includes a plunger chamber that creates negative pressure to fill the one or more collection containers. The plunger chamber is armed using a pivotable locking arm and a trigger coupled to the arm. Methods of using the system for transporting a liquid from a chamber into one or more collection containers is also provided.

### CROSS-REFERENCE TO RELATED APPLICATIONS

This application claims the benefit of U.S. Provisional Patent Application No. 63/143,587, filed Jan. 29, 2021, which application is incorporated herein by reference in its entirety.

### INTRODUCTION

Analysis of a biological sample often involves determining presence of a target analyte in the sample. The target analyte, if present, is isolated from the sample and analyzed using downstream applications, such as, amplification, immunoassay, and the like. Target analytes such as nucleic acid is isolated using approaches that include column-based isolation and purification, reagent-based isolation and purification, magnetic bead-based isolation and purification, and other technologies. Reagents, kits and instruments that find use in isolating and purifying nucleic acids are available. Poor sample preparation can lead to suboptimal results in downstream applications, and it is for this reason that optimized versions of kits have emerged to address variation in sample source, be it blood, plant tissue, fungi, bacteria, or virus.

A sample preparation process includes releasing a nucleic acid from its native biological source (e.g., lysis of cells, such as patient cells or lysis of microorganisms, such as, virus, bacteria, fungi, etc.) using chaotropic nucleic acid extraction technology, binding of nucleic acids to a solid phase (e.g., paramagnetic particles) using silica or iron oxide nucleic acid chemistry, separation of the solid phase from the residual lysis solution using magnetic separation technology, washing to remove unwanted materials, and elution or separation of nucleic acid from the solid phase using fluid handling technology. At the completion of the sample preparation protocol, the liquid comprising the nucleic acid is transferred to a collection container(s) such as PCR tubes or strips. There is an interest in automating all or individual aspects of sample preparation to increase throughput, decrease user error and/or limit exposure of users to harmful substances.

### SUMMARY

Aspects of the present disclosure include a system for transporting a liquid from a chamber into one or more collection containers. The system may be semi-automatic or fully automatic. The system may be present in a sample preparation device, such as a cylindrical cartridge. The system includes a plunger chamber that creates negative pressure to fill the one or more collection containers. The plunger chamber is controlled using a pivotable locking arm and a trigger coupled to the arm.

Methods of using the system for transporting a liquid from a chamber into one or more collection containers is also provided.

### BRIEF DESCRIPTION OF THE FIGURES

FIG. 1 depicts an exploded view of a sample preparation cartridge 100 according to one embodiment.

FIG. 2A shows the interior of the cylindrical structure 110 of the sample preparation cartridge depicted in FIG. 1.

FIG. 2B shows a plunger assembly according to one embodiment.

FIG. 2C shows the sealing plate assembly viewed from below. The pivotable locking arm is shown in a broken-out view. The trigger is shown in a further broken-out view.

FIG. 2D shows the pivotable locking arm 151 and the cap 160.

FIG. 3 shows a cutaway-view of a sample preparation cartridge according to one embodiment of the present disclosure. Some components of the cartridge are not shown.

FIG. 4 shows a cutaway-view of a sample preparation cartridge according to one embodiment of the present disclosure. Some components of the cartridge are not shown.

FIGS. 5A-5D show a sample preparation cartridge 100 in pre-arming stage where the cap is in a pre-activation stage and the spring is not yet armed.

FIGS. 6A-6D show a sample preparation cartridge 100 in armed stage where the cap is in a post-activation stage and the spring is armed.

FIGS. 7A-7D show a sample preparation cartridge 100 in negative-pressure-triggered stage. The locking arm 151 has pivoted relative to the shaft 152 of the sealing plate assembly.

FIGS. 8A-8B shows further details of fluidic channels present at the bottom end of the cartridge.

FIGS. 9A-9C shows configuration of channel 145 connecting chamber 140 and channel 146 connecting chamber 120 to collection containers 130.

FIGS. 10A-10C show additional drawings of the sealing plate assembly.

FIGS. 11A-11C show the cap 160 in isolation as viewed from different angles.

FIGS. 12A-12B show an instrument comprising a rotatable platform and a magnet.

FIG. 13 shows an exploded view of a sample preparation cartridge 300 according to an embodiment.

FIG. 14 shows a plunger assembly and a triggering assembly.

FIG. 15 shows a cut-out view of the plunger assembly.

FIG. 16 shows a plunger assembly.

FIGS. 17A-17D shows a sample preparation cartridge in an cap-open state, prior to arming of the plunger assembly.

FIGS. 18A-18D shows a sample preparation cartridge in an cap-closed state, after arming of the plunger assembly.

FIGS. 19A-19D shows a sample preparation cartridge in a negative-pressure-triggered stage.

FIG. 20A shows top view of the sealing plate assembly of the sample preparation cartridge 300.

FIG. 20B shows view of the bottom of the cap 360 of the sample preparation cartridge 300.

FIGS. 21A and 21B show the sample preparation cartridge in cap open and closed state, respectively.

FIG. 21C shows a magnet accessory configured for holding a sample preparation cartridge.

### DETAILED DESCRIPTION

Aspects of the present disclosure include a system for transporting a liquid from a chamber into one or more collection containers. The system may be semi-automatic or fully automatic. The system may be embodied in a sample preparation device, such as a cylindrical cartridge. The system includes a plunger chamber that creates negative pressure to fill the one or more collection containers. The plunger chamber is controlled using a pivotable locking arm and a trigger coupled to the arm.

Methods of using the system for transporting a liquid from a chamber into one or more collection containers is also provided.

Before the present systems, sample preparation devices and methods are described in greater detail, it is to be understood that the present disclosure is not limited to particular embodiments described, as such may, of course, vary. It is also to be understood that the terminology used herein is for the purpose of describing particular embodiments only, and is not intended to be limiting.

Where a range of values is provided, it is understood that each intervening value, to the tenth of the unit of the lower limit unless the context clearly dictates otherwise, between the upper and lower limit of that range and any other stated or intervening value in that stated range, is encompassed within the present systems, sample preparation devices and methods. The upper and lower limits of these smaller ranges may independently be included in the smaller ranges and are also encompassed within the systems, sample preparation devices and methods, subject to any specifically excluded limit in the stated range. Where the stated range includes one or both of the limits, ranges excluding either or both of those included limits are also included in the systems, sample preparation devices and methods.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating un-recited number may be a number which, in the context in which it is presented, provides the substantial equivalent of the specifically recited number.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present systems, sample preparation devices and methods, representative illustrative systems, sample preparation devices and methods are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present sample preparation cartridges, methods, and sample preparation units. Any recited method can be carried out in the order of events recited or in any other order which is logically possible.

### Systems for Negative Pressure Filling

As summarized above, aspects of the present disclosure include systems and sample preparation devices, such as, sample preparation cartridges that are configured for transporting a liquid from a chamber into one or more collection containers. These systems and sample preparation devices comprising such systems are useful for transporting a solution (e.g., an elution buffer) comprising or suspected of comprising a target analyte into one or more collection containers for analysis of the target analyte. The semi-automated or fully automated filling of the collection containers reduces dependence on a user while minimizing user error. Use of negative pressure to fill the collection container(s) can have several advantages as compared to using a plunger in the chamber to directly force the liquid out. For example, use of negative pressure can increase the amount of liquid transferred out of the chamber to minimize loss of target analyte. In addition, the shape of the chamber and the plunger need not perfectly matched to generate sufficiently leak-proof seal to force the liquid out of the chamber.

According to certain embodiments, the system for transporting a liquid from a chamber into one or more collection containers may include a plunger chamber, a pivotable locking arm, and a trigger attached to the arm. The plunger chamber may include a plunger assembly and a spring. In certain embodiments, the spring part of the plunger assembly may be positioned outside the plunger chamber. When armed, the plunger assembly compresses the spring. The pivotable locking arm, when in a first position, engages with the plunger assembly to arm the plunger assembly. The pivotable locking arm, when in a second position, disengages with the plunger assembly allowing the plunger assembly to retract away from the spring and create a vacuum in the plunger chamber. The trigger is coupled to the pivotable locking arm. The trigger when engaged by a force or a physical interference causes the locking arm and the plunger assembly to disengage. The plunger chamber is fluidically connected to a channel connecting the chamber to the one or more collection containers. The vacuum created in the plunger chamber draws the liquid from the chamber via the channel into the one or more collection containers.

In certain embodiments, the system includes two collection containers. In certain embodiments, the system includes three collection containers. In certain embodiments, the system includes four or more collection containers. In certain embodiments, the two or more collection containers each include substantially equal volume of the liquid in the chamber. For example, the volume of the liquid transferred to the two or more containers may not differ by more than ±20%. In certain examples, the chamber comprising the liquid has a volume of about 1 ml-100 ul, e.g., 750-100 ul, 500-100 ul, or 250-100 ul. The system may transfer the entire volume or a portion thereof to a collection chamber. When two or more collection chambers are present, the system may transfer approximately equal volumes of the liquid to the two or more containers. In certain cases, the chamber may include around 250 ul of the liquid and the system may transfer the liquid to two collection containers, where each container receives about 125 ul of the liquid.

In certain embodiments, the system includes two collection containers and the channel connecting the chamber to the two collection containers bifurcates into two sub-channels fluidically connected to the two collection containers.

The collection containers may be any suitable container. In certain embodiments, the collection containers may be PCR tubes or similar thin-walled containers or strips conducive to thermal cycling reactions or isothermal reactions.

According to certain embodiments, the plunger chamber is substantially cylindrical in shape and the plunger assembly includes a rigid structure and a cylindrical compressible structure. The rigid structure includes a narrow-elongated region having a substantially curved end and a substantially flat end opposite the curved end. The curved end engages with the locking arm and the flat end is attached to the compressible structure. The flat end may be wider for improved attachment with the compressible structure. The compressible structure forms a seal with the interior surface of the plunger chamber. The curved end reduces the friction between the plunger assembly and the locking arm thereby reducing the amount of force required to cause relative movement between the plunger assembly and the locking arm. The seal formed between the compressible structure and the interior surface of the plunger chamber facilitates purging of air from the chamber and associated channels when the locking arm pushes down on the plunger assembly. The seal also facilitates creation of negative pressure by forming a vacuum when the locking arm releases the downward pressure on the plunger assembly thereby allowing the plunger assembly to retract. The spring facilitates forming of the vacuum by increasing the force with which the plunger assembly retracts after removal of the downward pressure by the locking arm. While the plunger chamber is exemplified herein as having a cylindrical structure, other shapes of the plunger chamber are also possible. For example, the plunger chamber and the compressible structure of the plunger assembly may be cubical or cuboidal in shape.

The height and diameter of the plunger chamber can vary based upon the volume of the liquid in the chamber, viscosity of the liquid, amount of liquid to be transferred, the material of the spring, and the like. In certain examples, the plunger chamber may have a height of 10 cm-1 cm, e.g., 5 cm-1 cm, 4 cm-1 cm, or 3 cm-1 cm. The plunger chamber may have an internal diameter of 1 cm-0.1 cm, e.g., 1 cm-0.3 cm or 1 cm-0.5 cm. The plunger chamber may have an interior volume of about 1 ml-200 ul, e.g., 900 ul-300 ul, 800 ul-300 ul, or 700 ul-400 ul. The plunger chamber and the rigid structure of the plunger assembly may be formed from a plastic. The compressible structure of the plunger assembly may be formed from rubber or similar material. The flat end of the plunger assembly may be substantially cylindrical and have a diameter that matches that of the compressible structure. The compressible structure may be substantially cylindrical in shape and have a diameter such that it forms a seal with the inner surface of the plunger chamber. The seal may be sufficiently tight to prevent significant amount of air from passing through the seal while allowing relative movement of the plunger assembly and the plunger chamber. The spring may be disposed in the plunger chamber under the plunger assembly and in contact with the compressible structure. The spring may have a diameter that is substantially equal to or is smaller than the diameter of the plunger chamber. The height of the spring may be such that the spring is uncompressed in absence of downward pressure from the locking arm. In certain examples, the height of the spring may be such that the spring is slightly compressed in absence of downward pressure from the locking arm. The plunger chamber includes an opening in the top end which opening is sufficiently large to allow placement of the plunger assembly and the spring in the plunger chamber. The bottom end of the plunger chamber includes a smaller opening configured to contain the plunger assembly and spring and is sufficiently wide to allow movement of air. In certain embodiments, the bottom end of the plunger chamber is substantially flat. In other embodiments, the bottom end of the plunger chamber may be curved.

In certain embodiments, the pivotable locking arm may be a substantially flat elongated structure comprising a first region and a second region. Optionally, the second region may comprise an extension that extends below the plane of the flat elongated structure. The first region may be pivotably attached to a shaft and the second region engages with the plunger assembly. The second region may have a reduced area surface as compared to the first region. The reduced surface area represents a narrower surface available for contacting the plunger assembly. The narrower surface facilitates removal of pressure from the plunger assembly when the locking arm is moved by requiring a relatively small movement. The surface area of the second region may be reduced to provide a narrower surface by presence of a notch in the second region. In certain embodiments, the notch may be present on a side edge of the second region of the locking arm. In certain embodiments, the notch may be present in a central area of the second region of the locking arm, for example, the notch may be a through-hole sized for the curved end of the plunger assembly to pass through the hole. In certain embodiments, the second region includes two notches, where the first and second notches are located on opposite side edges of the second region or where the first notch is located on a side edge and the second notch is located in the middle of the second region. The second region of the locking arm may include a first area that contacts the curved end of the plunger assembly and a second area adjacent the first area, where the second area includes a ramp leading to the notch. The ramp may accelerate the movement of the curved end of the plunger assembly towards the notch, thereby increasing the momentum with which the plunger assembly slides into the notch. The ramp may thus reduce the amount of force required to move the locking arm relative to the plunger assembly. The notch may be curved and the diameter of the curve sufficiently large to allow the curved end of the plunger assembly to slide through. In embodiments, where the notch is located on only one side edge of the second region of the locking arm, it is understood that the notch is located at the side edge which is moved towards the plunger assembly to release the downward pressure on the plunger assembly.

According to certain embodiments, the trigger may be removably coupled to the locking arm. The trigger may be made from a magnetically responsive material and may be configured to snap into or onto the locking arm. The magnetically responsive material may be iron, nickel, cobalt, oxides thereof, derivatives thereof, and combinations thereof. In other embodiments, the trigger may be fixedly coupled to the locking arm. For example, the locking arm and the trigger may be a single structure formed by injection molding. In certain embodiments, the locking arm may be substantially planar, and the trigger may extend downwards from the locking arm. In other embodiments, the locking arm and the trigger may be located in the same plane.

An actuation assembly may be included in the present system for placing the pivotable locking arm in the first position to arm the plunger assembly. The actuation assembly may include a cap. The cap may include a first surface opposite a second surface, a plurality of push rods extending from the second surface. The first region of the pivotable locking arm may include an opening through which the locking arm is pivotally attached to the shaft and includes a lip region surrounding the opening, the lip region configured to provide a surface area engageable by the push rods at two contact points located substantially diametrically opposite to each other. The system may include a sealing plate assembly comprising a substantially planar region comprising an upper surface opposite a lower surface, where the shaft is located in the sealing plate assembly and extends at least below the plane of the sealing plate assembly, and optionally above the plane of the sealing plate assembly. The locking arm is pivotably and slidably positioned on the shaft. The locking arm is disposed adjacent the lower surface of the sealing plate assembly prior to being engaged by the push rods at the two contact points. Upon engagement with the push rods, the locking arm is configured to slide down the shaft, away from the lower surface.

The shaft may have a large effective diameter at a region adjacent the lower surface as compared to a region further away from the lower surface such that the pivotable arm pivots more freely around the shaft when the locking arm is pushed away from the lower position adjacent the lower surface.

The sealing plate assembly may include two through-apertures located on diametrically opposite sides of the shaft, where the apertures are aligned with the contact points on the locking arm and the push rods such that the push rods pass through the apertures to contact the locking arm.

The shaft may be hollow and may include indents located in the interior surface. The cap may include a centrally located engagement structure extending from the second surface of the cap, the engagement structure comprising protrusions that reversibly fit into the indents. When the protrusions are positioned in the indents, the push rods are not in contact with the locking arm.

The engagement structure may be a rod-shaped structure comprising a plurality of fingers extending from a distal end of the rod-shaped structure, where the protrusions are located at a distal end of the plurality of fingers and where the shaft in the sealing plate assembly has a diameter larger than the diameter of the engagement structure and where the shaft comprises a lip at a distal end. Upon application of downward pressure on the cap, the protrusions disengage from the indents allowing the engagement structure to slide down the shaft such that the protrusions are located under the lip and the cap cannot be retracted.

In certain embodiments, a sample preparation device, such as the cylindrical cartridge described herein, may include the disclosed system for transporting a liquid from a chamber into one or more collection containers. Thus, the sample preparation device may include the chamber and the one or more collection containers. The sample preparation device may further include the plunger chamber, pivotable locking arm, trigger, sealing plate assembly and cap. In the sample preparation device, the sealing plate assembly is fixedly positioned over the top end of the device and the cap is fixedly positioned over the sealing plate assembly. In the pre-activation stage, the cap is fixedly positioned in a spaced-apart manner from the upper surface of the sealing plate assembly. In the post-activation stage, the cap is fixedly positioned adjacent the upper surface of the sealing plate assembly. The sample preparation device may also include additional chambers for sample preparation. For example, the device may include a chamber in which a biological sample is combined with a lysis buffer and magnetic particles that bind to a target analyte, e.g., nucleic acids present in the sample. Magnetic particles may be referred to as capture beads. These magnetic particles may be functionalized to capture a target analyte. For example, magnetic particles may include a surface that binds to nucleic acid. Magnetic particles may include immobilized oligonucleotides, peptides, and/or proteins that bind to a target analyte. The device may also include a chamber for removing non-specifically attached molecules, cell debris, etc. from the magnetic particles. Such a chamber may include a non-aqueous phase that is immiscible with the lysis buffer or may include a wash solution.

As used herein, the term “distal end” refers to the end located further away from a reference point as compared to a proximal end which is located closer to the reference point. In this context, the distal end of the rod-shaped structure is the end located towards the bottom end of the rod-shaped structure while the top end of the rod-shaped structure is attached to the cap. The terms “horizontal” and “vertical” are used to indicate direction relative to an absolute reference, i.e., ground level. However, these terms should not be construed to require structures to be absolutely parallel or absolutely perpendicular to each other. For example, a first vertical structure and a second vertical structure are not necessarily parallel to each other. The terms “top” and “bottom” or “upper” or “lower” are used to refer to surfaces where the top is always higher than the bottom relative to an absolute reference, i.e., the surface of the earth. The terms “upwards” and “downwards” are also relative to an absolute reference; upwards is always against the gravity of the earth while downwards is always towards the gravity of the earth.

In certain embodiments, the sample preparation device may be a cylindrical cartridge that includes the present system for transporting a liquid from a chamber into one or more collection containers. Accordingly, a cylindrical cartridge that comprises a system of components for transferring a liquid from a chamber into one or more collection containers is provided. The cylindrical cartridge may include a cylindrical structure having a top end, a bottom end and an annular wall extending between the top and bottom ends. The chamber comprising the liquid, e.g., elution buffer, may be located in the annular wall. The cylindrical structure may include a plurality of chambers located in the annular wall, where the chambers extend between an exterior surface of the annular wall and an interior of the cylindrical structure. The cylindrical cartridge includes the plunger chamber, pivotable locking arm, trigger, sealing plate assembly and cap described herein. While the sample preparation device is exemplified as a cylindrical cartridge, a cylindrical shape is not necessary. For example, instead of a cylindrical structure, a sample preparation cartridge comprising the system for transporting a liquid from a chamber into one or more collection containers may have a cubical or a cuboidal shape.

Further details of the systems and sample preparation devices of the present disclosure are provided with reference to figures depicting particular embodiments. It is understood that the systems and sample preparation devices, such as the cartridges described herein, are not limited to a particular figure and may be modified.

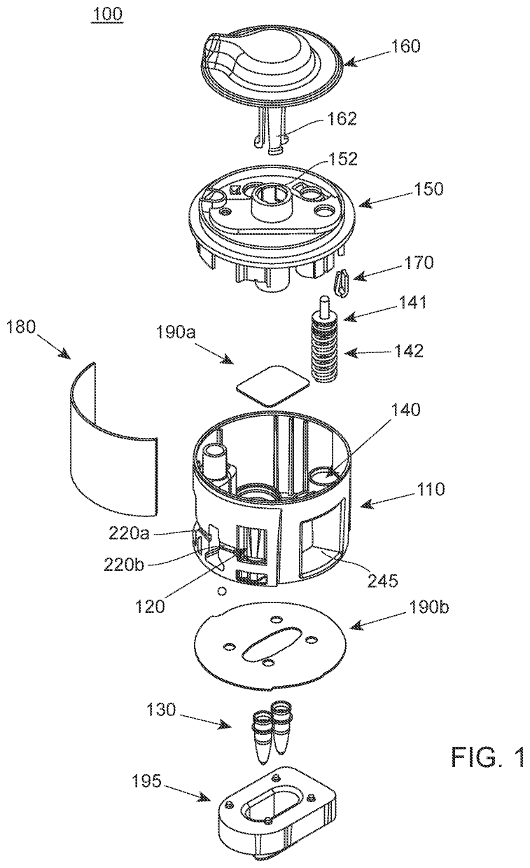

FIG. 1 depicts an exploded view of a sample preparation device provided herein. The sample preparation device is a cylindrical cartridge that includes a cylindrical structure 110 comprising a chamber 120. The chamber 120 is fluidically connected to collection containers 130 and to plunger chamber 140. A plunger assembly 141 and a spring 142 are disposed in the plunger chamber 140. The top end of the cylindrical structure 110 is closed by a sealing plate assembly 150. The sealing plate assembly 150 is connected to cap 160. A trigger 170 is also depicted. Cover 180 is affixed to outer surface of the annular wall. Sealing films 190a and 190b are affixed to a top surface and bottom surface, respectively, of a bottom surface of the cylindrical structure and form channels fluidically connecting the chamber 120 to collection container 130 and plunger chamber 140. A clip 195 for attaching the collection chambers to the bottom surface of the cylindrical structure is shown. Engagement structure 162 extending from lower surface of the cap is depicted. The engagement structure 162 includes three protrusions which engage with indents present inside shaft 152 of the sealing plate assembly, when the cap is in a pre-activation stage. These protrusions are pushed below the lip of the shaft and are not retractable when the cap in a down position.

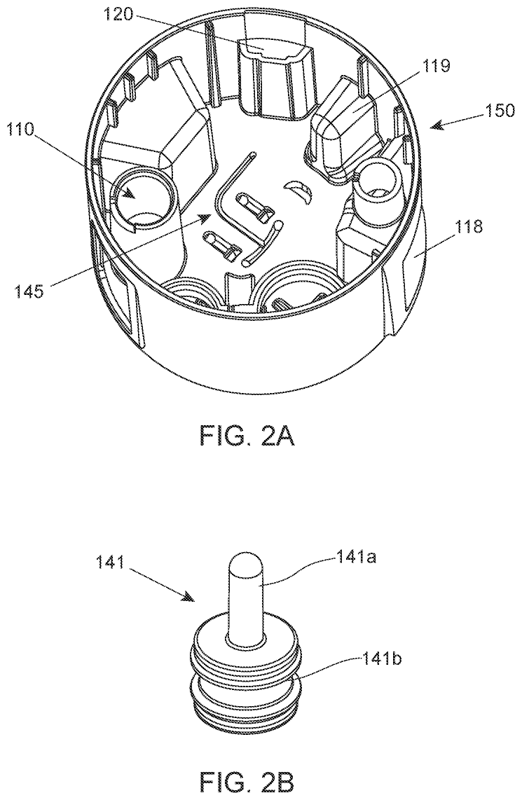

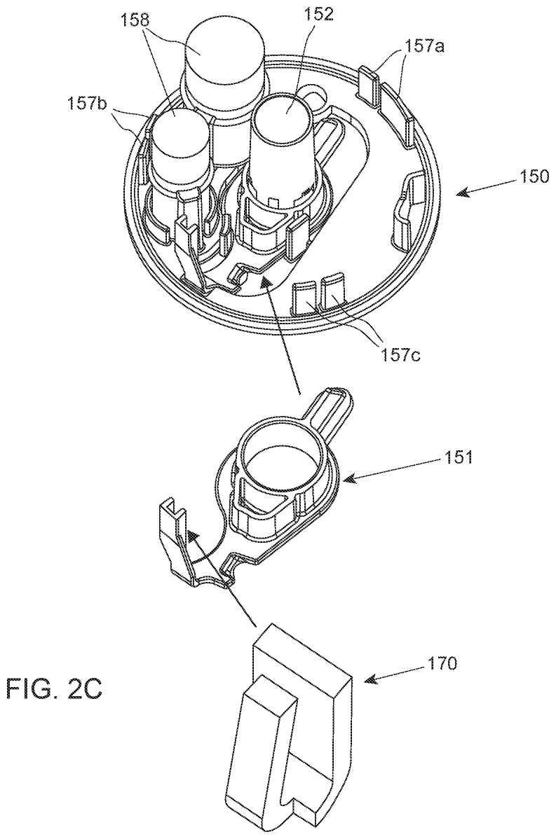

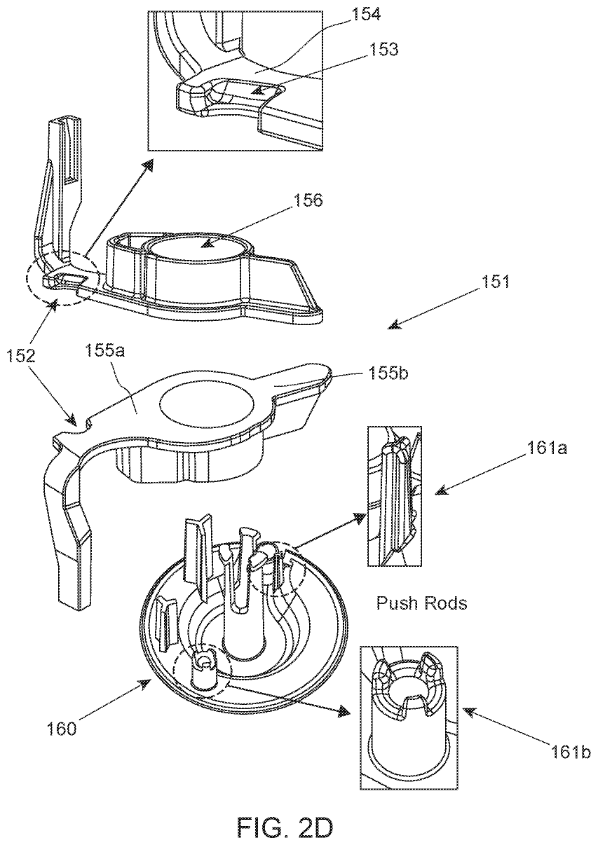

FIG. 2A shows the interior of the cylindrical structure 110 of the sample preparation cartridge depicted in FIG. 1. The channel 145 fluidically connecting the chamber 120 to collection containers is partially visible. Plunger chamber 140 is also depicted. FIG. 2B shows the plunger assembly 141 having a rigid structure 141a with a curved end and a compressible structure 141b. The figures are not drawn to scale.

FIG. 2C shows the sealing plate assembly viewed from below. The centrally located shaft 152 is visible. The locking arm 151 slidably and pivotably disposed on the shaft is depicted. Magnified views of the locking arm 151 and trigger 170 attached to the locking arm 151 are shown.

FIG. 2D shows the pivotable locking arm 151 and the cap 160. The top two images shows the pivotable locking arm 151 in an upside-down orientation. The locking arm 151 includes a first region that has an opening 156 and a second region narrower than the first region and comprising a notch 152. The second surface of the locking arm is shown in the top-most image. The second surface forms a ramp 153 leading to the notch to facilitate the movement of the curved end of the plunger assembly from a region 154 of the second surface to the notch 152. The third image depicts the locking arm in right-side-up orientation. The area of the locking arm surrounding the opening 156 provides a lip comprising two points of contact 155a and 155b on the top surface, which contact push rods 161a and 161b, respectively. The cap 160 is depicted in an upside-down orientation. The push rods are designed to apply pressure on the locking arm 151 using a relatively small point of contact to lower the friction between the top surface of the locking arm and the push rods when the locking arm is moved around the central opening 156 or the shaft rotates while the locking arm in held in place.

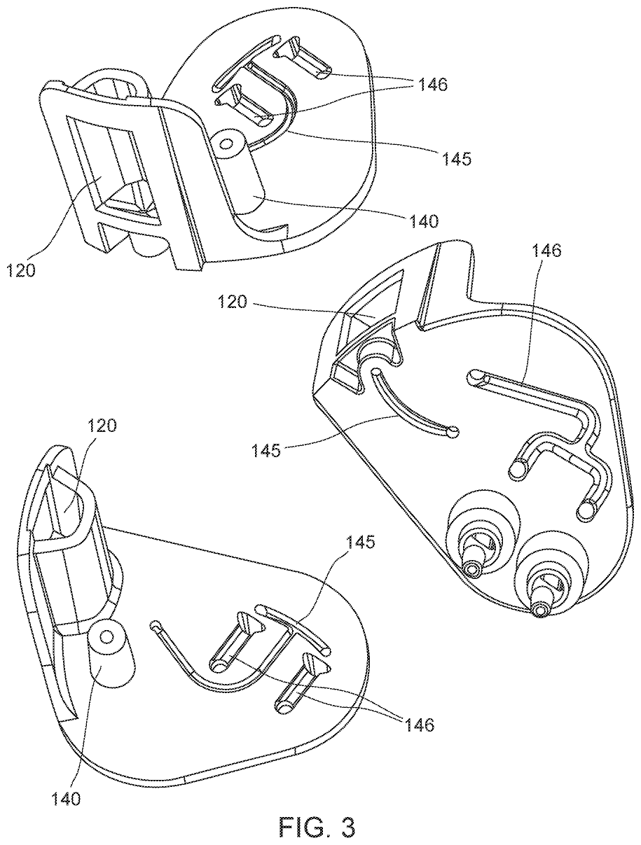

FIG. 3 shows a cutaway-view of a sample preparation device. A chamber 120 from which liquid is transferred to collection containers (not shown) and a plunger chamber 140 are depicted in different orientations. Channels 145 and 146 are fluidically connecting the chamber, plunger chamber and collection containers is partially depicted. Specifically, channel 145 connects the chamber 120 to the collection containers while channel 146 connects the plunger chamber 140 to the collection containers.

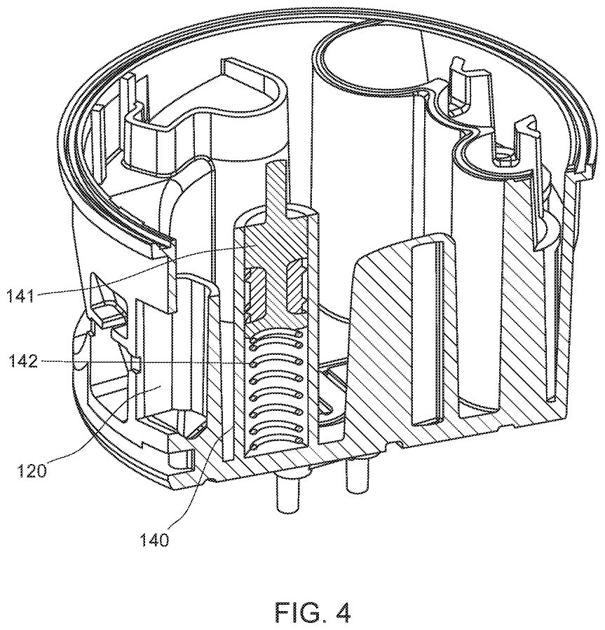

FIG. 4 shows a cutaway-view of a sample preparation cartridge. The sample preparation device includes a chamber 120 and plunger chamber 140. A plunger assembly 141 and a spring 142 are disposed in the plunger chamber 140.

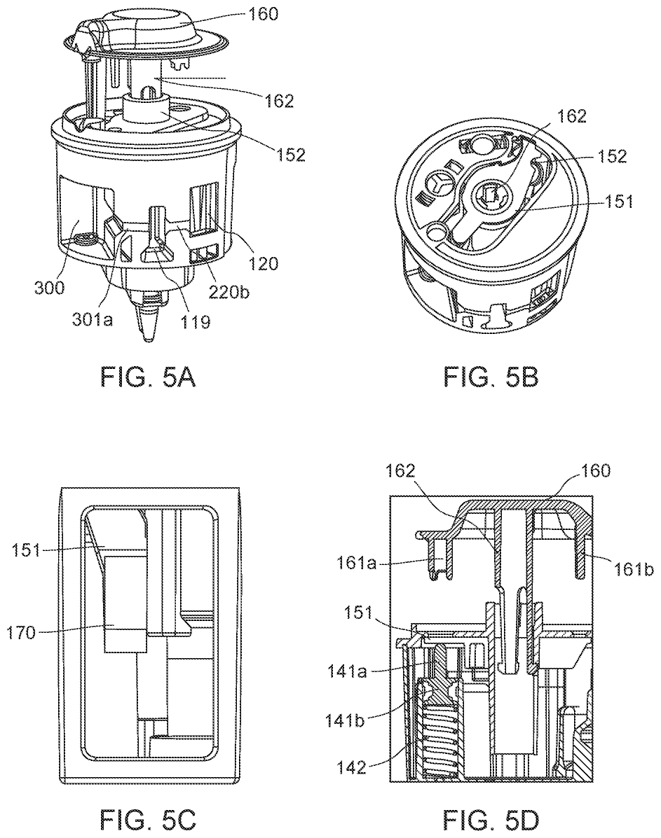

FIGS. 5A-5D show a sample preparation cartridge 100 in a pre-arming stage where the cap is in a “pre-activation” stage and the spring is not yet armed. In FIG. 5A, cap 160 is in the pre-activation stage. In the pre-activation stage, the protrusions (see FIG. 1) of engagement structure 162 are locked into the indents located in the inner surface of shaft 152. FIG. 5B is a cutaway view from top of the cartridge 100. The cap 160 and portions of the sealing plate assembly are not shown to allow for a clearer image. Engagement structure 162 is partially visible in FIG. 5B inside the shaft in the sealing plate assembly. The locking arm 151 with notch 152 located on a side edge of the locking arm is also visible. FIG. 5C is a closeup of a region of the locking arm 151 which region extends down from the plane of the remainder of the locking arm. Trigger 170 is attached to the locking arm 151. In the pre-activation stage, the locking arm and trigger are positioned at a higher level in the cartridge. FIG. 5D shows an internal view of the cartridge. The rigid structure 141a of the plunger assembly 141 is in contact with the locking arm and compressible structure 141b is in contact with spring 142. The spring 142 is uncompressed when the cap is in the pre-activation stage.

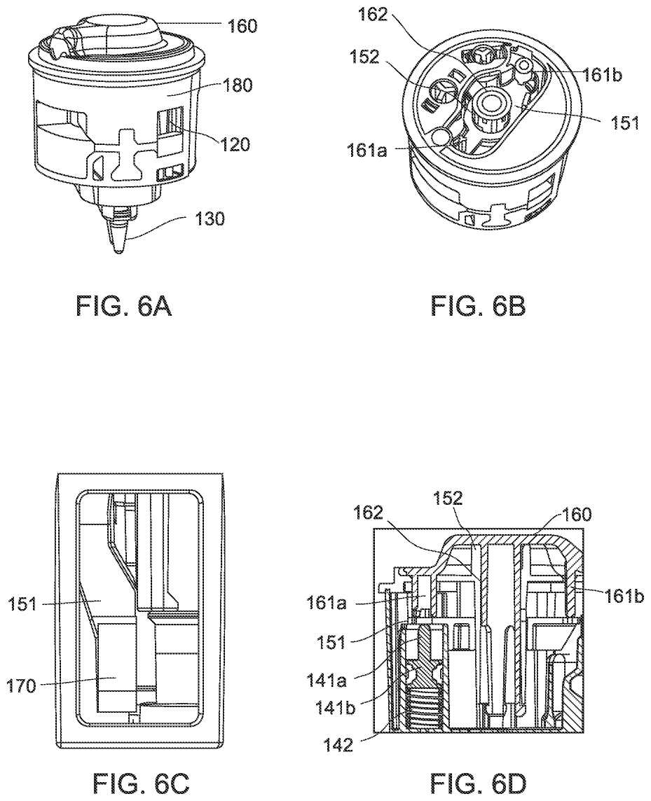

FIGS. 6A-6D show a sample preparation cartridge 100 in armed stage where the cap is in a post-activation stage and the spring is armed. The cap 160 is pressed down. The push rods 161a and 161b drive the locking arm 151 and trigger 170 downwards. The locking arm 151 presses down on the plunger assembly 141 which in turn compresses the spring 142. The downward movement of the plunger assembly 141 drives air out of the plunger chamber 140. The system is now armed. In FIG. 6A, the chamber 120 is shown as filled with the liquid to be transferred to collection containers 130. Also visible is cover 180. In FIG. 6B, the locking arm 151 has traveled down the shaft 152. A cutaway view shows the engagement structure 162 of the cap inserted into shaft 152 and push rods 161a and 161b pushed down onto the locking arm 151. FIG. 6C shows a closeup view of part of the locking arm 151 that extends downwards and the trigger 170 attached to the locking arm 151. As compared to FIG. 5C, the locking arm and trigger have moved downwards within the cartridge. In FIG. 6D, the interior of the cartridge is shown. The engagement structure 162 of the cap 160 is located inside the shaft 152 of the sealing plate assembly with the protrusion of the engagement structure located below the end of the shaft 152 where they prevent removal of the cap.

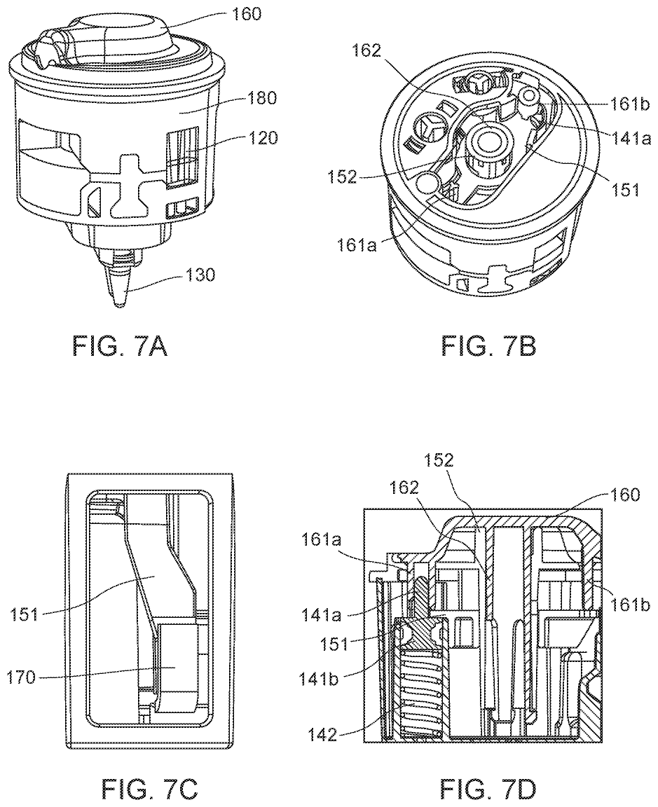

FIGS. 7A-7D show a sample preparation cartridge 100 in negative-pressure-triggered stage where the rigid structure of the plunger assembly has moved through the notch of the locking arm 151 and the downward pressure by the plunger assembly has been removed. Removal of the downward pressure causes the spring to fire upward. Due to the compressible structure on the plunger assembly forming a seal with the interior wall of the plunger chamber, the upward motion creates a drop in air pressure in the new volume created below. This drop in pressure causes the liquid in chamber 120 to be drawn out and divided approximately equally between the 2 PCR tubes 130 on the bottom of the cartridge. FIG. 7A depicts the chamber 120 with the liquid transferred out. FIG. 7B shows that the position of the locking arm 151 relative to shaft 152 is unchanged. Due to rotation of the shaft relative to the locking arm 151, the rigid structure 141a has moved through the notch present on a side edge of the locking arm 151. FIG. 7C shows that relative to the position of the locking arm and trigger in FIG. 6C, the locking arm 151 and trigger 170 have moved laterally as the locking arm 151 rotates about the shaft 152. FIG. 7D shows that the engagement structure 162 of cap 160 is locked with the shaft 152 and the push rods 161a and 161b are still pushing down on locking arm 151, the rigid structure with curved end 141a has passed through the notch in the locking arm and the spring 170 has been released from the compressed state and the compressible structure 141b of the plunger assembly has been pushed upwards, creating a vacuum in the plunger chamber.

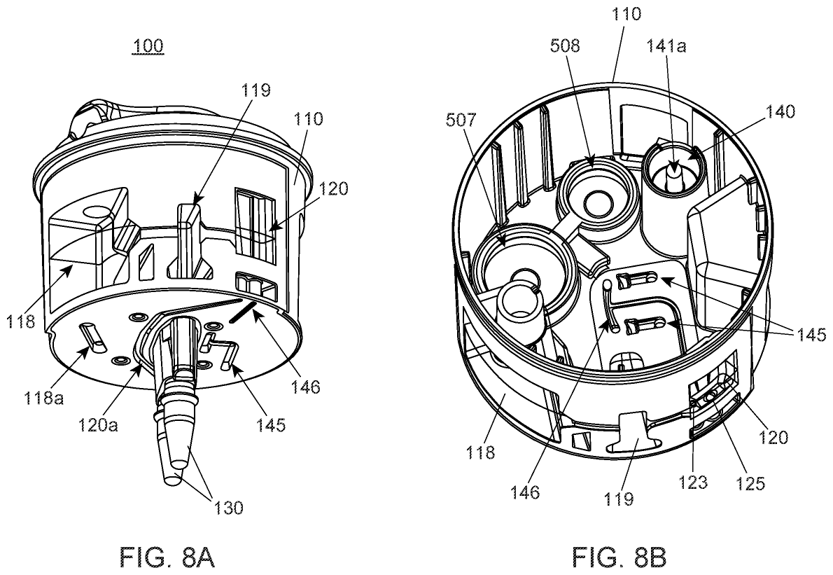

An exemplary configuration of the channels connecting the chamber 120 to the collection containers 130 is now described. This configuration is especially useful when the objective is to divide the liquid in the chamber 120 equally between multiple collection containers, e.g., two collection containers 130 as depicted in FIG. 8A. FIG. 8A shows a sample preparation cartridge 100 with cylindrical structure 110 comprising three chambers located at the annular wall. Chamber 118 is fluidically connected to channel 118a. Channel 118a can be used for filling chamber 118 with a fluid, e.g., lysis buffer. Chamber 120 is fluidically connected to a channel 120a. Channel 120a can be used for filling chamber 120 with a fluid, e.g., an elution buffer. Channel 120a connects to a bottom region of chamber 120 via an inlet 123. In this example, chamber 119 contains ambient air and is not connected to a channel. Channel 146 connects the chamber 120 with the collection containers 130. Channel 146 is connected to drain hole 125 at a bottom region of the chamber 120. Channel 145 connects the plunger chamber 140 with the collection containers 130. In FIG. 8B, the plunger chamber 140 is visible along with channel 145 and channel 146. Both channels include a T-junction. As the negative pressure is generated, air is displaced from the system which causes the liquid to be pulled from the chamber 120 and dispersed into the collection containers 130. The liquid pathway in channel 146 and the pathway in channel 145 in which air is displaced resides high enough above the final liquid fill height within the collection containers to prevent submersion in liquid as liquid is distributed into the collection containers. This prevents the air displacement pathways on channel 145 from becoming wet and prematurely stopping the filling of the collection containers. Additional features depicted in FIG. 8B include buffer pack support features 507 and 508 which can hold bottom ends of buffer packs installed in the cartridge. Channel 118a extends from the bottom of buffer pack support feature 507 to chamber 118. Channel 120a extends from the bottom of buffer pack support feature 508 to chamber 120.

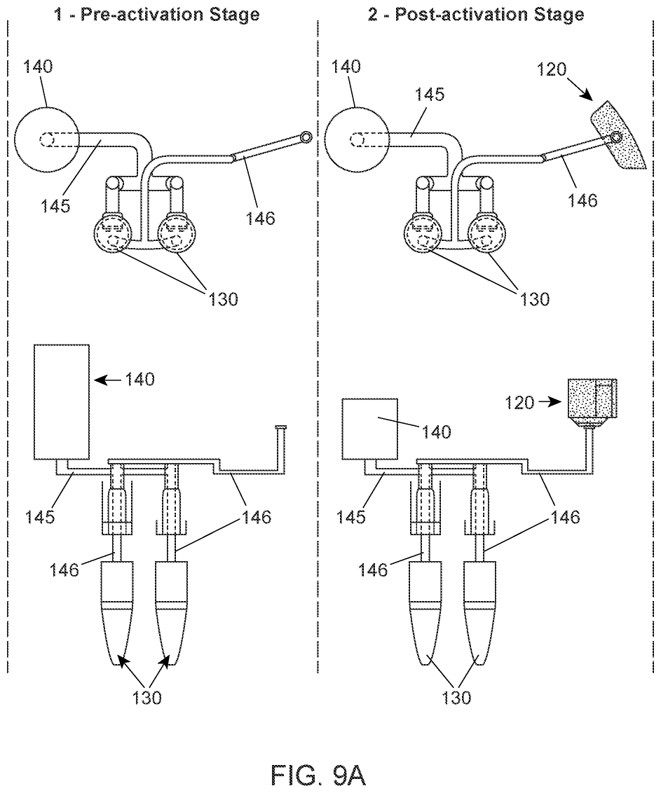

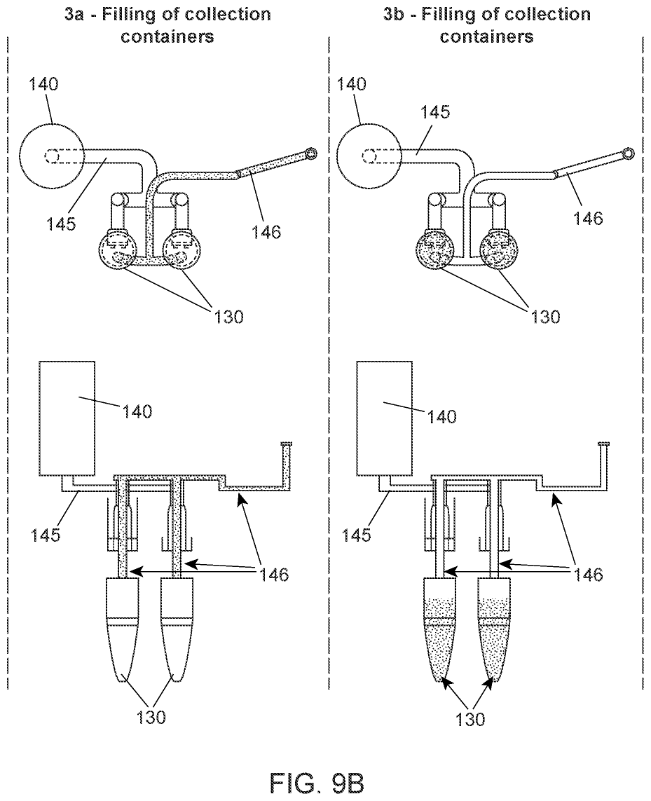

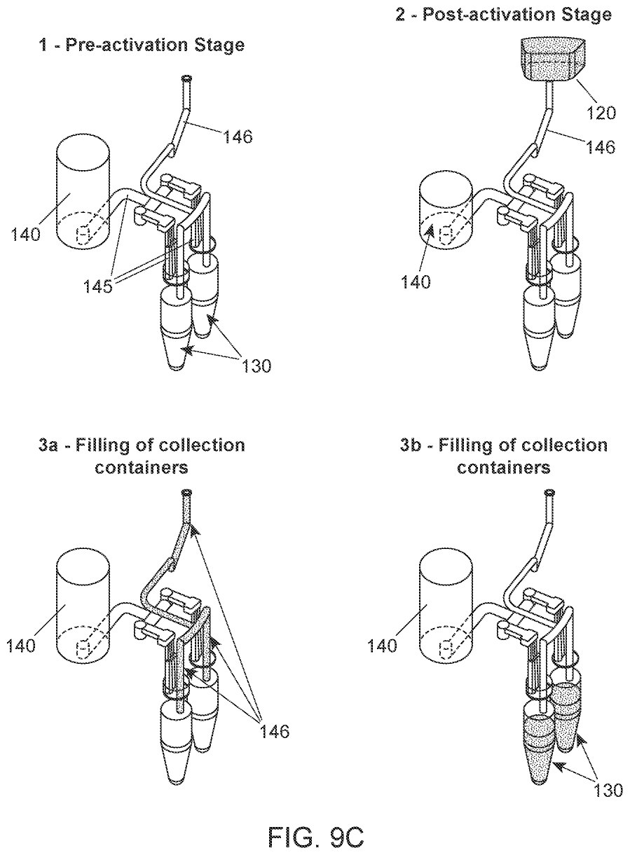

FIGS. 9A-9C provide additional details of configuration of the air-displacement channel 145 and the liquid pathway channel 146. In FIGS. 9A-9B, the upper panels show a view of the chambers and channels as viewed from the top of the cartridge. The lower panels show a side-view of the chambers and channels. In the pre-activation stage, where the cap is placed in a spaced-apart manner from the upper surface of the sealing plate assembly and the spring is not yet armed (see 1—Pre-activation Stage), the system is full of air at ambient air pressure. The plunger chamber 140, channels 145 and 146 and collection containers 130 are occupied with atmospheric air. 2—Post-activation Stage, when the cap is pressed, a fluid (e.g., elution buffer) fills into chamber 120. The pressing down of the cap also compresses the plunger assembly and arms the spring. Downward movement of the compressible structure 141b displaces air out of the plunger chamber. The displaced air vents to atmosphere. As explained in FIGS. 5-7, the trigger 170 moves downwards when the cap is in post-activation stage and the spring is armed. 3a and 3b-filling of collection containers, this process happens rapidly and has been split into two sections for purposes of explanation. When the trigger 170 is moved laterally, the spring fires up, pushing the compressible structure 141b upwards, generating the negative pressure in the system. The negative pressure creates a suction force in channel 145 and collection chambers 130 which in-turn draw the fluid from chamber 120 into the channel 146. As the negative pressure draws the fluid through, it enters the two collection containers. Since the remaining air pressure in the collection containers is equal, the fluid equally divides between the collection containers. In FIGS. 9A-9C, the chamber 120 is not depicted when it is empty, i.e., does not contain a liquid. Clear chamber and channels indicate that the space within is occupied by air or vacuum. Stippled chamber and channel indicate present of liquid.

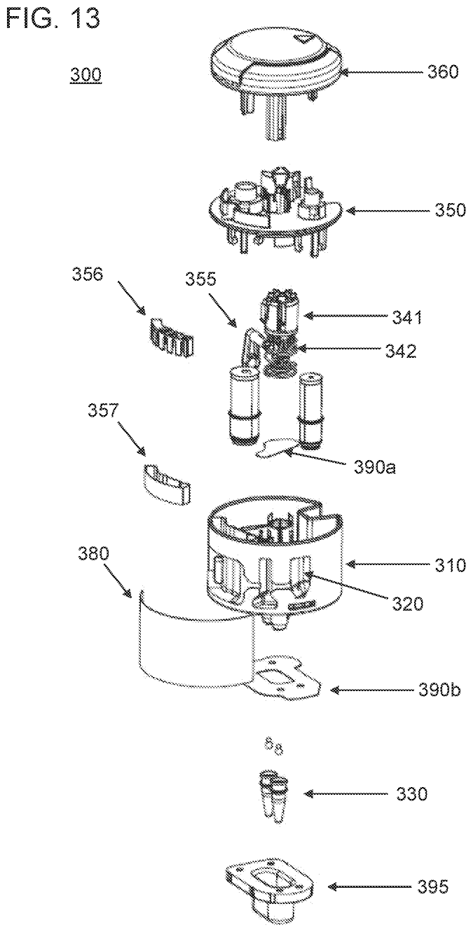

FIG. 13 depicts an exploded view of a sample preparation device 300 provided herein. The sample preparation device is a cylindrical cartridge that includes a cylindrical structure 310 comprising a chamber 320. The chamber 320 is fluidically connected to collection containers 330 and to plunger chamber 340 (not seen in this view). A plunger assembly 341 is positioned in the plunger chamber 340. A sealing plate assembly 350 is affixed to the top end of the cylindrical structure 310. The sealing plate assembly 350 is covered by cap 360. A trigger assembly 355 is also depicted. Flexible cover 380 is affixed to outer surface of the annular wall of the cylindrical structure 310. Sealing films 390a and 390b are affixed to a top surface and bottom surface, respectively, of a bottom region of the cylindrical structure and form channels fluidically connecting the chamber 320 to collection container 330 and plunger chamber 340. A clip 395 for attaching the collection chambers to the bottom surface of the cylindrical structure is shown.

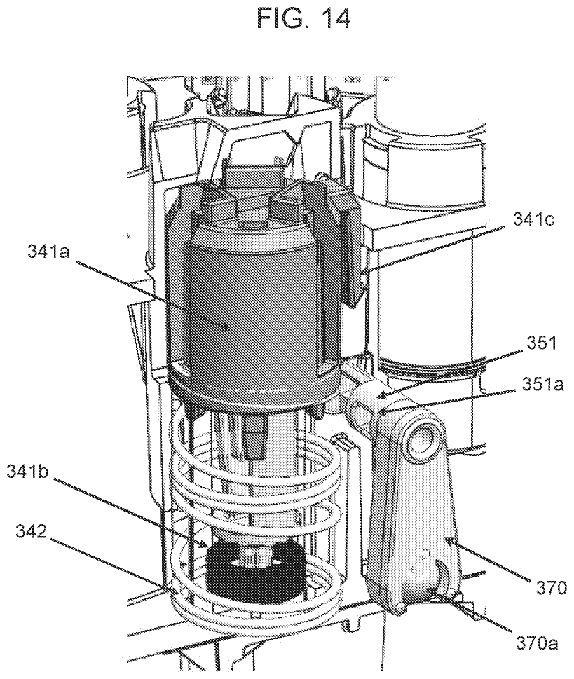

FIG. 14 shows a zoomed-in view of plunger assembly 341, spring 342, and trigger assembly 355. The rigid structure 341a of the plunger assembly 341 includes an outer region having a diameter larger than the outer diameter of the plunger chamber and substantially equal to the diameter of the spring 342 such that when moved downwards, the outer region of the rigid structure engages with the spring. The inner region of the rigid structure 341a is sized to fit in the interior of the plunger chamber. The inner region of the rigid structure is fixedly attached to the compressible structure 341b. Compressible structure 341b is positioned in the interior of the plunger chamber (not shown in this view). The outer region of the rigid structure 341a of the plunger assembly 340 includes an engagement structure 341c sized to fit into a cut-out 351a in a pivotable engagement arm 351. The pivotable engagement arm 351 is attached to a movable trigger 370. The trigger 370 is movable in a direction towards the plunger chamber by application of a magnetic force to a metallic ball 370a. Movement of trigger 370 forces the engagement arm 351 to pivot clockwise. Clockwise movement of the engagement arm 351 allows release of engagement structure 341c from the cut-out 351a.

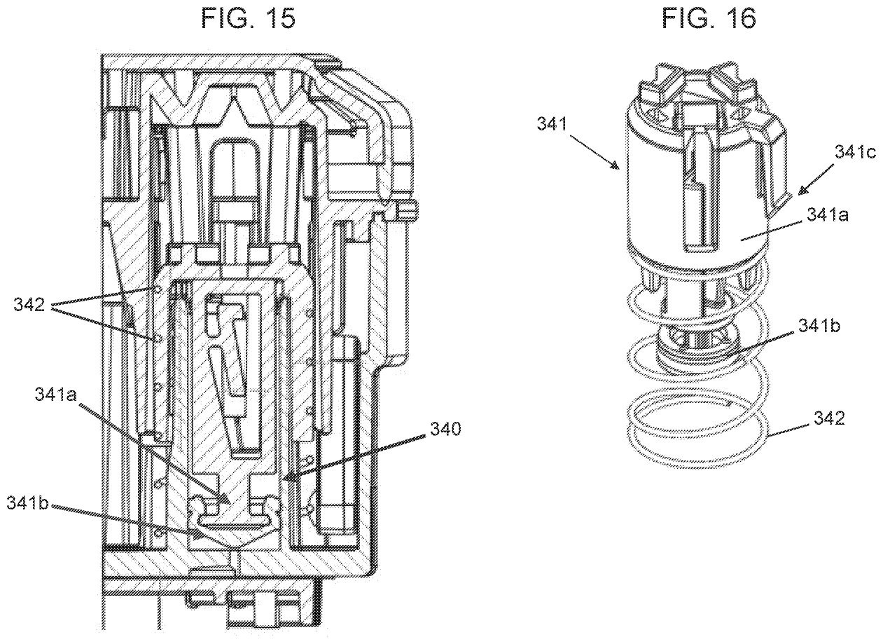

FIG. 15 shows a cut-away view of the plunger chamber 340, spring 342, rigid structure 341a, compressible structure 341b.

FIG. 16 shows plunger assembly 341 and spring 342. The rigid structure 341 includes engagement structure 341c.

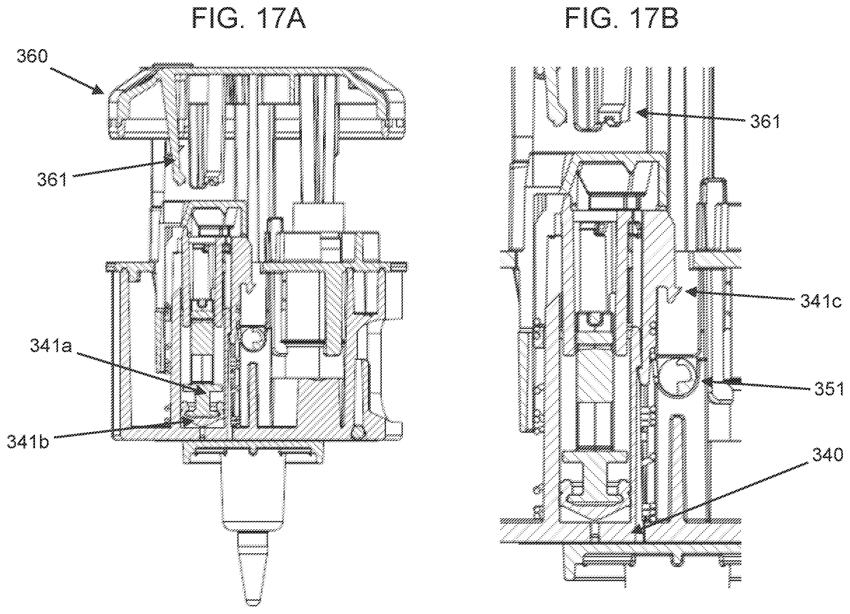

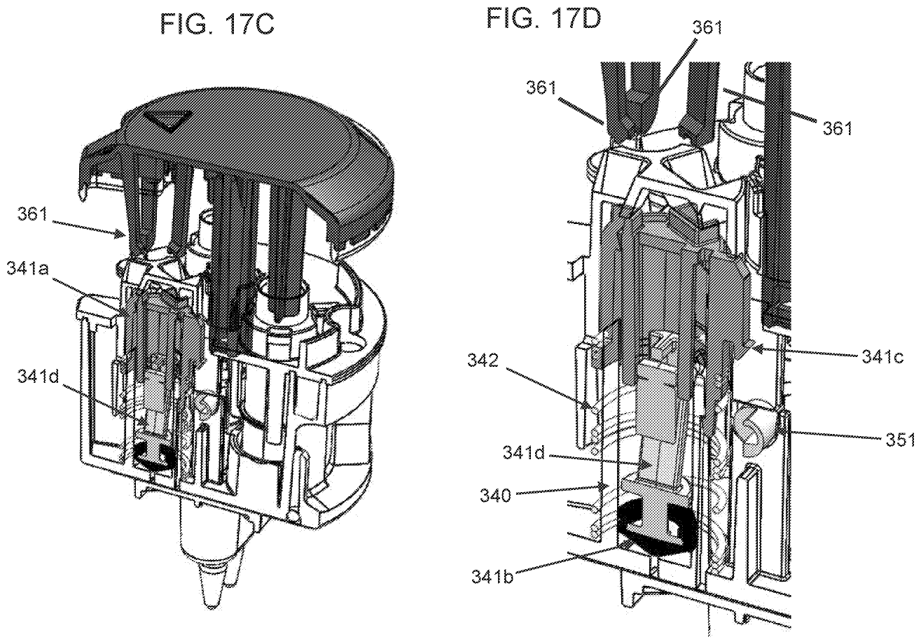

FIGS. 17A-17D show the sample preparation cartridge 300 in a pre-arming stage where the cap is in a “pre-activation” or open stage and the plunger assembly is not yet armed. The cap 360 is positioned over the cylindrical structure. A centrally located shaft extends from the bottom region of the cap and is aligned with a through opening centrally located in the sealing plate. Three push rods 361 extending from the bottom region of the cap are configured to be placed above and in vertical alignment with the plunger assembly. A cut-away view of the plunger assembly shows an internally positioned ramp 341d over which the rigid structure slides down upon application of downward pressure on the rigid structure 341a by push rods 361. In the cap-open stage, compressible structure 341b is positioned in the bottom region of plunger chamber 340. The rigid structure 341a of the plunger assembly 341 includes an inner region that is positioned in the interior of the plunger chamber and an outer region that is positioned around the exterior of the plunger chamber. The engagement structure 341c is positioned outside the plunger chamber. The inner region of the rigid structure 341a includes a ramp 341d, relative to which the rigid structure can move downwards upon application of downward pressure on the rigid structure and upwards upon release of the downward pressure. Trigger 370 is omitted in this view.

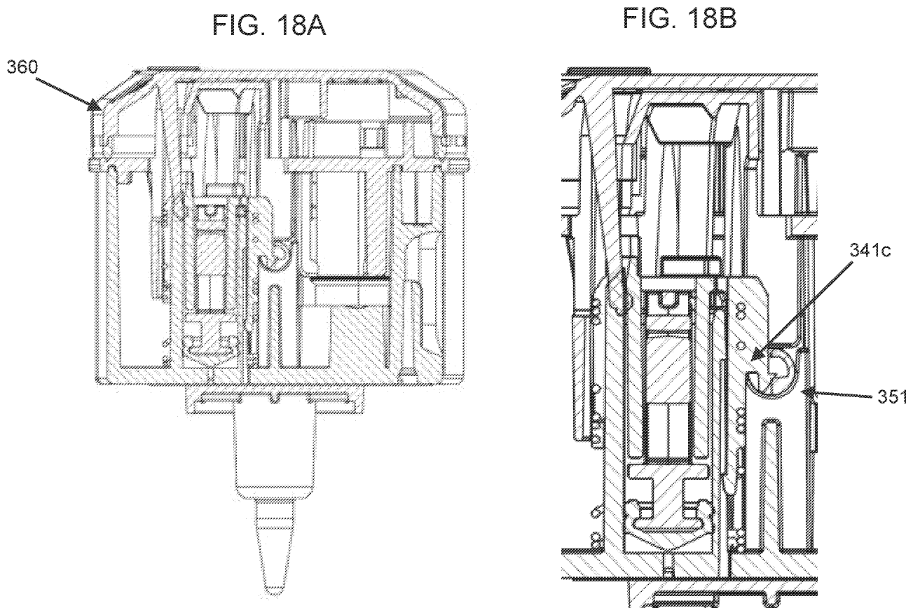

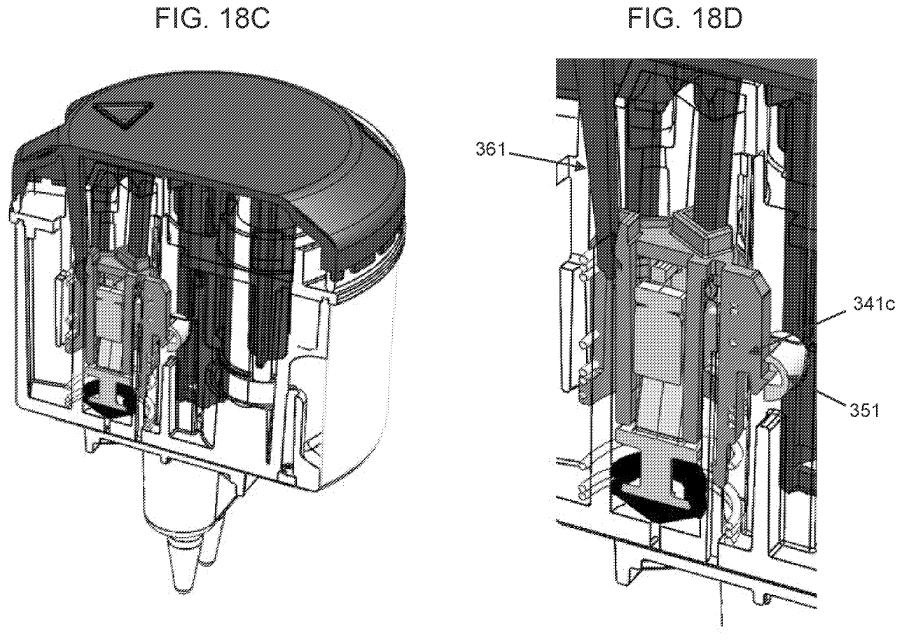

FIGS. 18A-18D show the sample preparation cartridge 300 in armed stage where the cap 360 is in a post-activation stage and the plunger assembly is armed. In this stage, push rods 361 have engaged the rigid structure 341 and forced the engagement structure 341c down into the cut-out 351a of pivotable locking arm 351 and the spring 342 is compressed. Trigger 370 is omitted in this view.

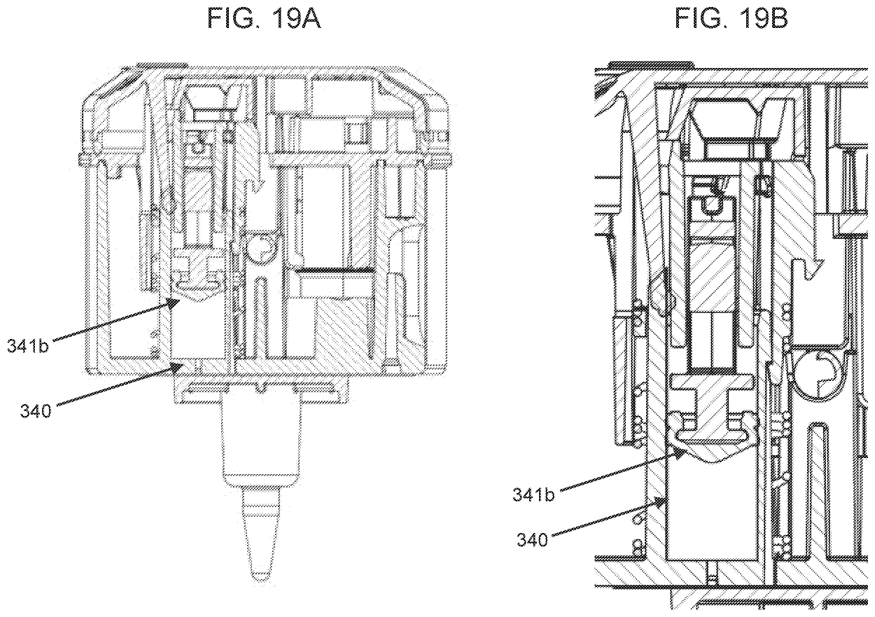

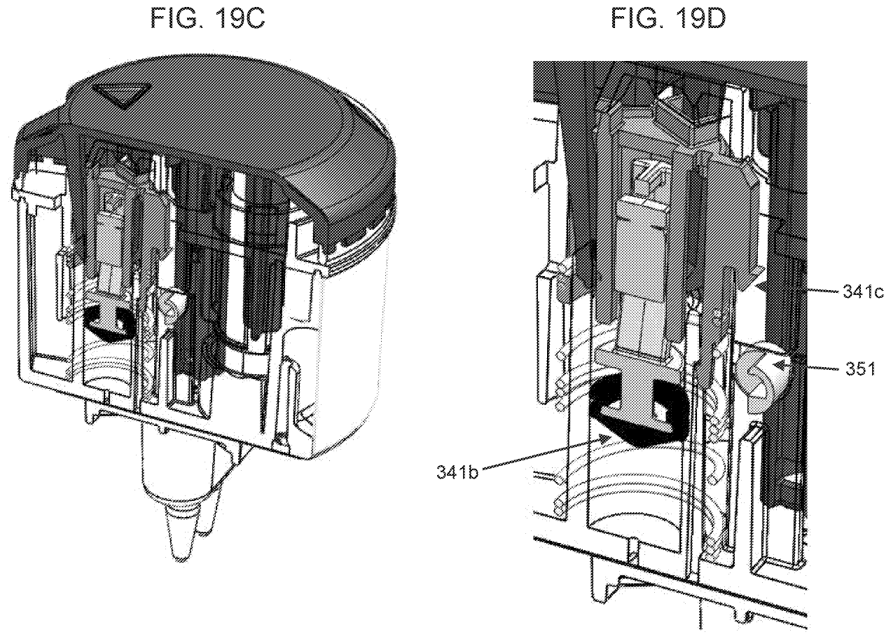

FIGS. 19A-19D shows show a sample preparation cartridge 300 in negative-pressure-triggered stage where the rigid structure of the plunger assembly has moved back up. The upward movement of the rigid structure is facilitated by ramp 341d and leads to the upward movement of the compressible structure 341b thereby creating a negative pressure in the plunger chamber 340. The upward movement is caused by release of the structure 341c from the cut-out in pivotable locking arm 351. Trigger 370 is omitted in this view.

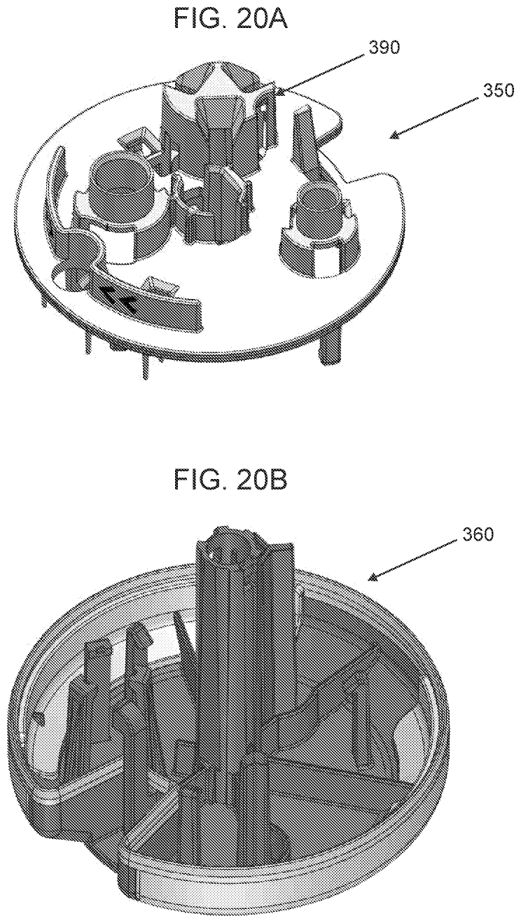

FIG. 20A shows the upper surface of the sealing plate 350 that is fixedly attached to the cylindrical structure of the cartridge. The sealing plate includes an alignment structure 390 with three-through holes configured to allow passage of push rods 361 extending from the lower surface of the cap 360 (FIG. 20B).

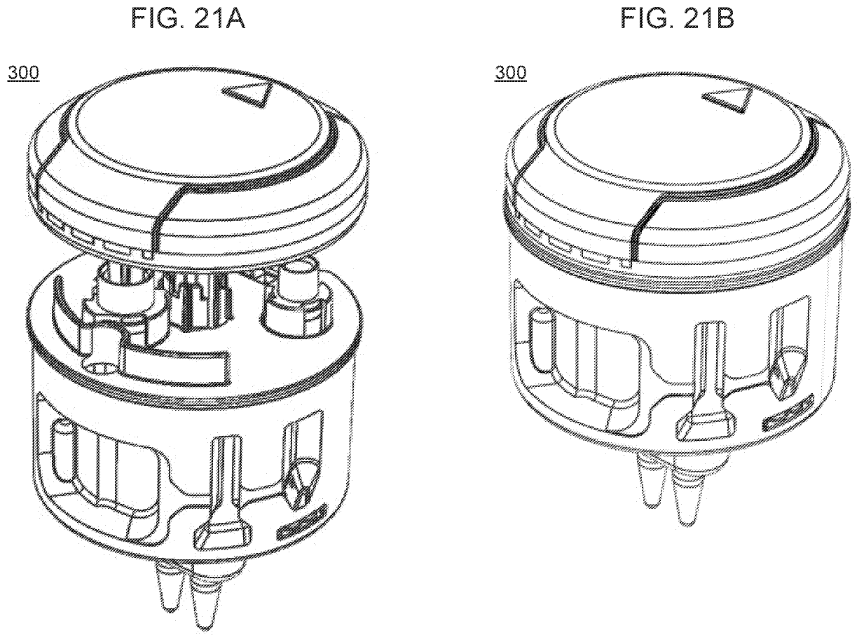

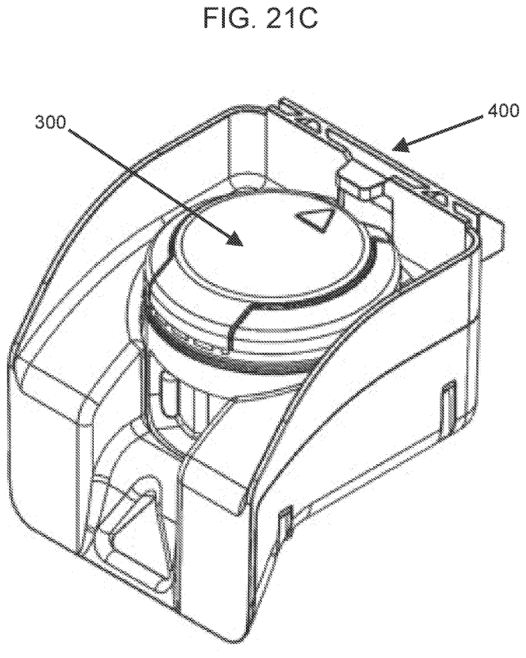

FIG. 21A and FIG. 21B show the sample preparation cartridge in cap open and closed state, respectively. FIG. 21C shows a magnet accessory which is configured to hold sample preparation cartridge 300 in close contact to one or more magnets (not shown). The magnet accessory may be sized to fit into an instrument comprising a motor for rotating the sample preparation cartridge.

While the sample preparation cartridge may have numerous chambers for preparation of a sample, e.g., for isolating nucleic acid from a sample, the sample preparation cartridge depicted in the figures includes at least three chambers. The chambers may be present in the interior of the cartridge or in some same on the exterior surface. In the cartridge depicted in the figures, the annular wall comprises cavities forming an open side of each of the plurality of chambers, and one or more channels providing fluidic communication between the plurality of chambers. The channels are formed by recesses in the annular wall and comprise an open side. One or more covers are affixed over exterior surface of the annular wall to cover and fluidically seal the open side of the chambers and the open side of the recesses. The plunger chamber may be present in the interior of the cartridge. The plunger chamber may be located adjacent the chamber from which the liquid is transferred out. Additional components of the sample preparation cartridge are described in greater detail below.

Cylindrical Structure

By cylindrical, it is meant that the cylindrical structure may be substantially a right circular cylinder. The cylindrical structure may be rotatable around the axis formed by a line connecting the center of the bottom end of the cylindrical structure with the center of the top end of the cylindrical structure. For example, the cylindrical structure may rotate clockwise when the cylindrical structure is viewed from above looking down onto the top of the cylindrical structure or may rotate counterclockwise. Alternatively, the cylindrical structure may rotate both clockwise and counterclockwise. In some instances, the range of motion of the cylindrical structure may encompass an entire revolution or less around the axis of the cylinder, such as three-fourths of a revolution, or one-half of a revolution or one-third of a revolution. In certain embodiments, the cylindrical structure may rotate a full revolution in the clockwise direction and a full revolution in the counterclockwise direction. In certain embodiments, the cylindrical structure may rotate a full revolution in the clockwise direction and less than a full revolution in the counterclockwise direction, or vice versa. Rotation of the cylindrical structure may be used for mixing contents of the one or more chambers or positioning a magnet present in the cylinder housing adjacent a chamber to cause aggregation of magnetic particles present in the chamber and/or to transfer aggregated magnetic beads from one chamber to another, to trigger the rotation of the locking arm to create negative pressure in the plunger chamber, etc.

As summarized above, the cylindrical structure comprises a plurality of cavities in the annular wall that form a plurality of open-sided chambers on the annular wall. For example, the plurality of cavities may be indentations in the annular wall that deform the continuous surface of the annular wall. By open sided, it is meant that the annular wall does not cover such side of the chamber. In certain instances, the deformed annular wall may form closed sides of the chambers, and the area corresponding to the side of the annular wall that was deformed to form the cavity may form the open side of the chambers.

According to certain embodiments, the open sides of the plurality of chambers are located on the exterior of the annular wall. For example, the annular wall may be deformed inward from the outside to form an inwardly deformed cavity in the annular wall. In such case, the open side of the chamber may be the area corresponding to the side of the annular wall that was deformed inward to form the cavity. In such instances, the annular wall that has been inwardly deformed may form closed sides of the chambers. The volume of a chamber may represent a measurement corresponding to the volume of the indentation in the annular wall. The chambers may be any convenient volume, and in some instances may vary from 1 cm³ to about 5 cm³, such as 1 cm³ to 3 cm³ or 2 cm³ to 5 cm³. In other instances, the chambers can contain any convenient volume of fluid, and in some instances may vary from 1 μL to about 5,000 μL, such as 1 μL to 100 μL or 1,000 μL to 3,000 μL or 2,000 μL to 5,000 μL. Each chamber of the plurality of chambers may have the same volume or may have different volumes. The depth of the chamber, measured as the distance from the outside surface of the annular wall to the inner side of the chamber, may be any convenient size, and in some instances, may be 0.1 cm or greater, such as 1 cm or 5 cm. Each chamber of the plurality of chambers may have the same depth or may have different depths.

According to certain embodiments, the plurality of chambers is positioned proximal to each other on the annular wall. For example, the distance between a lateral border of a first chamber and the closest lateral border of a second chamber may be about 0.1 cm or more, such as 0.5 cm to 1 cm, e.g., 0.5 cm or 0.75 cm or 5 cm. The distances between lateral sides of pairs of chambers positioned next to each other may be the same for the plurality of chambers or may differ. The plunger chamber may be located adjacent the third chamber, which may be the chamber where an analyte isolated from a sample is present. This chamber is also referred to as an elution chamber. The plunger chamber may be located adjacent the annular wall, on the annular wall, or more centrally inside the cylindrical structure. In certain example, the distance between a wall of the third chamber closest to the plunger chamber and the wall of the plunger chamber closest to the third chamber may be less than 5 cm, e.g., about 0.1 cm-4 cm, 0.5 cm-2 cm, and the like.

As summarized above, sample preparation cartridges include one or more channels that provide fluidic communication between the plurality of chambers. In certain aspects, the channels are wide enough that one or more paramagnetic particles (PMPs) used for isolating a target analyte can be transported therethrough. In certain embodiments, one or more of the channels between chambers are formed by recess in the annular wall. By recess in the annular wall, it is meant an indentation or a cavity in the annular wall capable of providing fluidic communication between chambers. In some cases, the recess is formed in the outside surface of the annular wall, such that a first chamber and a second chamber that are formed with open sides on the exterior surface of the annular wall are interconnected by a recess in the outside surface of the annular wall between such first chamber and second chamber. The recesses in the annular wall may be any convenient length, width and depth.

In certain embodiments, the recesses are positioned on the lateral sides of the plurality of chambers. By lateral sides of the plurality of chambers, it is meant the left- or right-hand sides and not the top or the bottom sides of the chambers, when the axis of the cylindrical structure formed between the center of the bottom end and the center of the top end of the cylindrical structure is oriented vertically. By positioning recesses on the lateral sides of the plurality of chambers, it is meant that a recess may interconnect the right-hand side of a first chamber with the left-hand side of a second chamber, such that such first and second chambers are in fluidic communication with each other via the recess. Recesses between chambers may be substantially straight lines between a point on a first chamber and a point on a second chamber. A recess between a first and second chamber may have substantially the same width and depth in the annular wall across the entire length of the recess or may vary. Recesses between different pairs of chambers may have different dimensions or same dimensions. Recesses may be shaped as convenient such that PMPs may be translated therethrough.

In certain embodiments, the recesses are positioned on the lateral sides of one or more chambers at a substantially constant height above the bottom end of the cylindrical structure. In these embodiments, the recesses between pairs of chambers may be substantially linear. In these embodiments, the recesses and the chambers may be shaped such that a path exists starting from the leftmost position on the leftmost chamber through each of the plurality of chambers to the rightmost position of the rightmost chamber, in a straight line. The recesses on the lateral sides of one or more chambers may be positioned at any convenient height above the bottom end of the cylindrical structure. In certain of these embodiments, the height above the bottom end of the cylindrical structure at which the recesses are positioned corresponds to the vertical midpoint of one or more of the chambers. In certain embodiments, the trigger attached to the locking arm when the locking arm is pressed downward by closing the cap, may be at approximately the same level as that of the recesses. In such embodiments, the same magnet used for transferring the PMPs from one chamber to another through the recesses may also be used to engage the trigger and prevent the trigger from moving while the cylindrical cartridge rotates. In other embodiments, a separate magnet is used for engaging the trigger.

In certain embodiments, the shape of one or more of the plurality of chambers is generally rectangular. By generally rectangular chamber, it is meant that the two-dimensional shape of the indentation into the annular wall is longer than it is wider. The height and width of each chamber may be any convenient height and width. The height and width of each rectangular chamber may be identical or may differ.

In certain embodiments, the shape of a chamber connected to another chamber by one or more channels is such that with respect to a lateral portion of the chamber that is proximal to a channel, the height of the chamber at each lateral position of the chamber decreases the closer such position is to the channel. In some cases, the height of such chamber at each lateral position decreases linearly so as to form a tapered region. Such a tapered entrance to the recess may facilitate transport of aggregated PMPs from the chambers to the channel.

In certain embodiments, one or more of the chambers comprises a drain hole. By drain hole, it is meant a hole through which fluid may exit the chamber. In certain embodiments, the drained hole is sized such that an appreciable amount of liquid cannot drain through the hole under the influence of the force of gravity.

The one or more of the chambers may include an opening which is configured for venting of the chamber, filling of the chamber with a fluid, and/or draining of fluid from the chamber.

In certain embodiments, the interior of the cylindrical structure comprises one or more wells. By wells, it is meant one or more enclosures within the inside of the cylindrical structure. The enclosures may be any convenient size or shape. For example, the enclosures may be substantially cylindrical, with a closed bottom end, an annular wall, and an open top end. In these embodiments, cylindrical structures may further comprise channels in the cylindrical structure that provide fluidic communication between such wells and one or more of the plurality of chambers. In some instances, each well is interconnected with a distinct chamber via one or more channels.

In certain embodiments, the plurality of chambers forms a first chamber, a second chamber and a third chamber. In certain embodiments, the first chamber is adjacent to the second chamber; the second chamber is adjacent to the first and third chambers; and the third chamber is adjacent to the second chamber. In certain embodiments, the cylindrical structure further includes a first recess in the annular wall providing fluidic communication between the first and second chambers, and a second recess in the annular wall providing fluidic communication between the second and third chambers. In certain embodiments, the first chamber is a lysis chamber; the second chamber is an immiscible phase chamber or a wash chamber; and the third chamber is an elution chamber. By lysis chamber, it is meant a chamber that during use of the sample preparation cartridge contains buffer a fluid, such as, a fluid that is a lysis buffer. By immiscible phase chamber, it is meant a chamber that during use of the sample preparation cartridge contains an immiscible phase, such as a fluid that is immiscible with aqueous phase. In some cases, the immiscible phase is oil. In other cases, the immiscible phase is air. By wash chamber, it is meant that the chamber during use of the cartridge contains a wash solution. By elution chamber, it is meant a chamber that during use of the sample preparation device contains an elution buffer a fluid, such as, a fluid that is an elution buffer. The plunger chamber may be located adjacent and in fluidic communication with the elution chamber.

The first chamber may include an opening at the top of the chamber. This opening may be configured as an inlet. The inlet may be configured for introducing a lysis buffer, a sample, and/or a mixture thereof. Thus, the inlet may have a diameter compatible for pipetting, injecting, or pumping a lysis buffer, a sample, and/or a mixture thereof. In some cases, the second chamber may also include an opening at the top of the chamber. This opening may be configured as an inlet for introducing an immiscible phase, e.g., oil into the second chamber. In some cases, the third chamber may also include an opening at the top of the chamber. This opening may be configured as an inlet for introducing an elution buffer into the third chamber.

In certain examples, the first chamber may include a compartment positioned on the bottom region or underneath the bottom region of the first chamber. The compartment may include an opening fluidically connecting the compartment to the interior of the first chamber. The compartment may include paramagnetic particles (PMPs). The PMPs may be lyophilized. In certain embodiments, the first chamber includes an opening at the bottom of the chamber, wherein the opening is configured as an inlet for lysis buffer and wherein the first chamber comprises an opening at the top of the first chamber configured as a sample inlet. In certain embodiments, the compartment includes an inlet fluidically connecting the compartment to a channel and an outlet fluidically connecting the compartment to the interior of the first chamber.

In certain examples, the second chamber may not include an opening other than the interconnections with the first and third chambers. The second chamber may contain air. When the first and third chambers are filled with a liquid the air in the second chamber is compressed due to lack of a vent in the second chamber. The compressed air serves as a “wash” environment for PMPs transferred from the first chamber to the third chamber via the second chamber comprising the compressed air.

In certain examples, the third chamber includes an opening at a bottom region of the chamber. The opening is configured for draining the third chamber. The third chamber may include an opening at a bottom region of the chamber wherein the opening is distinct from the opening for draining the third chamber and is configured for filling the third chamber. In certain cases, the draining hole may have a smaller diameter than the filling hole such that the draining hole does not allow liquid to pass through under atmospheric pressure and requires a higher pressure to allow passage of liquid. The opening at the bottom of the third chamber is fluidically connected to one or more collection containers. The collection containers may be two separate tubes, e.g., thin wall polypropylene tube suitable for PCR, as described above. The opening at the bottom of the third chamber may be fluidically connected to two channels that split from the opening to fill the two collection containers with substantially equal volume of liquid drained from the third chamber under the influence of the vacuum created in the plunger chamber.

A cylindrical cartridge 100 according to one embodiment is shown in FIG. 1. In this example, the cylindrical structure 110 includes three cavities in the annular wall that form three open-sided chambers 118, 119, and 120 on the annular wall and two recesses that form open-sided interconnections. In FIG. 1, only two of the chambers are visible. The third chamber 120 is fluidically connected to the collection containers 130 and plunger chamber 140. As seen, the open sides of the chambers 118, 119, and 120 are located on the exterior of the annular wall, and the chambers 118, 119, and 120 are positioned adjacent to each other. An interconnection 220a provides fluidic communication between chambers 118 and 119 and another interconnection 220b provides fluidic communication between chamber 119 and 120. In this example, the interconnections 220a and 220b are channels that are recesses in the annular wall, and the interconnection 220a is positioned on the lateral sides of the chamber 118 and 119 and the interconnection 220b is positioned on the lateral sides of the chambers 119 and 120. As illustrated in the figure, the recesses that form interconnections 220a and 220b between the chambers are at a substantially constant height above the bottom end of the cylindrical structure 110.

Covers

As summarized above, sample preparation cartridges include one or more covers that cover the open sides of the plurality of chambers and the interconnections to form channels. In certain aspects, a cover curves to mate with the outside surface of the cylindrical structure. By curves, it is meant that the cover is substantially not flat when attached to the cylindrical structure. When the cover covers a chamber, a fluid disposed in the chamber is contained in the chamber. Use of a cover to form a wall of the chambers in the cylindrical device allows for a wall that is significantly thinner that the annular wall of the cylindrical structure. Use of a cover to form a wall of the chambers in the cylindrical device allows for a wall that is made from a material different from the material of the cylindrical structure. In certain embodiments, a single cover may cover all of the plurality of chambers or may cover a subset of the plurality of chambers and all or a subset of the interconnections between the chambers. A cover may be any convenient size and shape, and the size and shape of the cover may vary.

A cover may be made from any suitable material that can be curved and attached to the exterior surface of the annular wall. For example, the cover may be made from plastic, metal, paper, glass, and the like. If metal material is used for the cover, the metal may be non-magnetic, i.e., not include substantial amount of iron. A paper cover may include a non-wettable coating, e.g., a wax coating. The cover may be substantially opaque or substantially transparent. The cover may be attached to the annular wall by any suitable means such as via an adhesive, locally heating the exterior of the annular wall or the cover or both, by snapping the cover into a groove(s) created in the annular wall, by screwing the cover into the annular wall, and the like. The cover may be sufficiently thin so as to not significantly decrease in the chambers the magnetic force of the external magnet. For example, the cover may be sufficiently thin to allow paramagnetic particles (PMPs) present in a chamber to be aggregated in response to the external magnet being located adjacent the chamber and to allow the aggregated PMPs to traverse thorough a channel connecting adjacent chambers in response to relative movement of the cylindrical structure and the external magnet. The cover may have a thickness of less than 1 cm, less than 0.5 cm, less than 0.1 cm, e.g., 1 mm-5 mm. In certain embodiments, the cover may be a film, e.g., an adhesive film.

According to certain embodiments, the interior surface of the cover facilitates movement of PMPs thereon. By facilitating movement of PMPs, it is meant that the interior surface of the cover may be configured such that PMPs may be more reliably translated from a first position on the cover to a second position on the cover while remaining in contact with the interior surface of the cover. For example, the interior surface of the cover may be polished to reduce friction between PMPs and the interior surface of the cover as the PMPs move along the cover. By translated from a first position on the cover to a second position on the cover, in certain cases, it is meant that the PMPs are moved along the interior of the cover; or, in certain cases, it is meant that the PMPs are held in a fixed position while the cartridge is moved from a first position to a second position; or, in certain cases, it is meant that both the PMPs are moved and the cartridge is moved.

By paramagnetic particles, it is meant magnetic particles capable of having an analyte of interest attached thereon, e.g., capable of having nucleic acids attached thereon. PMPs are magnetically responsive. Magnetically responsive particles include or are composed of magnetically responsive materials. Examples of magnetically responsive materials include paramagnetic materials, ferromagnetic materials, ferrimagnetic materials, and metamagnetic materials. Examples of suitable paramagnetic materials include iron, nickel, and cobalt, as well as metal oxides, such as Fe₃O₄, BaFe₁₂O₁₉, CoO, NiO, Mn₂O₃, Cr₂O₃, and CoMnP. PMPs may be comprised of a paramagnetic material enclosed in a non-magnetic polymer, such as, magnetic materials covered with a polymeric material or magnetic material embedded in a polymer matrix. Such particles may be referred to as magnetic or paramagnetic beads

Also visible in FIG. 1 is indentation 245 which may serve as a housing for providing additional functionalities to the cartridge. For example, the indentation may house a bar code or a QR code. The code may be directly printed on the cartridge or it may be printed on a substrate that is affixed on the cartridge. The code may be used to assign a unique identifier to the cartridge. The depth and position of the indentation may be matched to location of a code reader to ensure proper focus and alignment with the code reader.

FIG. 1 shows additional sealing films 190a and 190b that cooperate to provide top and bottom walls of channels connecting the chambers to individual wells in embodiments where wells are included in the cartridge and/or for connecting the chamber 120 to collection containers 130. For example, the channels may be openings in a bottom wall which openings extends from bottom of the chamber 120 to inlets for the collection containers. The side walls of the opening are formed by the bottom wall while the top and bottom walls are provided by sealing films 190a and 190b, respectively.

In some embodiments, the cartridge may include a plurality of chambers that include an opening at a top region. An opening at the top region of the first chamber may be used to introduce a lysis buffer, PMPs, and sample in the first chamber. The second chamber may include air as an immiscible phase and may not include an opening (other than the interconnections to the first and third chamber). The second chamber may include oil as an immiscible phase and may include an opening in the top region for introducing oil into the second chamber. The third chamber may include an opening for introducing an elution buffer in the third chamber which may be closed by the sealing plate assembly.

Buffer Pack

In certain embodiments, sample preparation cartridges may include a buffer pack. A buffer pack may comprise one or more fluid packs. Each fluid pack may contain a fluid. The fluid packs may contain any convenient fluid in any convenient amount. In some embodiments, fluid packs may comprise each of a lysis buffer pack, an immiscible phase pack and an elution buffer pack. In some embodiments, fluid packs may comprise a lysis buffer pack and an elution buffer pack. In certain embodiments, the immiscible phase may comprise an oil. In certain embodiments, the immiscible phase may comprise air. In some instances, one or more of the fluid packs may further comprise PMPs. or capture beads. The capture beads may be magnetic or non-magnetic. Capture beads may be functionalized to bind to a target analyte. Capture beads may have immobilized on a surface thereof, a moiety for binding to a target analyte. The moiety may be an oligonucleotide, a peptide, or a protein (e.g., an antibody). The fluid pack may contain any convenient amount of PMPs, measured based on, for example, the volume or the weight of PMPs. For example, the PMPs may be mixed with a fluid when included in a fluid pack. In some instances, PMPs may be included in a fluid pack that comprises a lysis buffer.

In certain embodiments, the buffer pack is configured to fit within the wells of the cylindrical structure. For example, when the wells are shaped as substantially hollow cylinders, the buffer pack may be shaped as cylinders that fit within the wells of the cylindrical structure.

In some embodiments, the lysis buffer can be formulated to release nucleic acid from a broad spectrum of samples, such as tissue samples, cells, viruses, or body fluid samples. The lysis buffer can also be designed to lyse all types of pathogens, such as viruses, bacteria, fungi, and protozoan pathogens. Such lysis buffer can contain a chaotropic agent, particularly, guanidine hydrochloride.

Sealing Plate Assembly

The sealing plate assembly includes a sealing plate positioned on top end of the cylindrical structure. The sealing plate may be substantially circular in shape and can snap into or onto the top region of the cylindrical structure and close the top end. The sealing plate may include a centrally located shaft of any suitable length. The shaft may be a hollow shaft. In certain embodiments, the shaft may extend above the sealing plate. In certain embodiments, the shaft may extend below the sealing plate. The length of the shaft below the sealing plate may be a length that is less than or equal to the height of the cylindrical structure.

An example of a sealing plate assembly 150 is shown in FIG. 2C. The top-most drawing illustrates the underside of the sealing plate assembly. Guide features 157a-157c placed uniformly about the periphery of the sealing plate are depicted. The shaft 152 of the sealing plate assembly has a higher effective outer diameter in region of the shaft immediately adjacent to the lower surface of the sealing plate. The pivotable locking arm 151 is initially disposed in a relatively tight fit about this region of the shaft. The higher effective outer diameter may be achieved by adding excess shaft material on the region.

In certain embodiments, the sealing plate may include an opening in a region of the sealing plate above the pivotable locking arm. The opening may be sufficiently large to expose two diametrically opposite regions of the locking arm. In other embodiments, the sealing plate may include two openings in two regions of the sealing plate above the pivotable locking arm. Also depicted in FIG. 2C but not required in some embodiments, are buffer packs 158 that may be used to supply lysis buffer and elution buffer to the chamber 118 and chamber 119 of the cartridge, respectively.

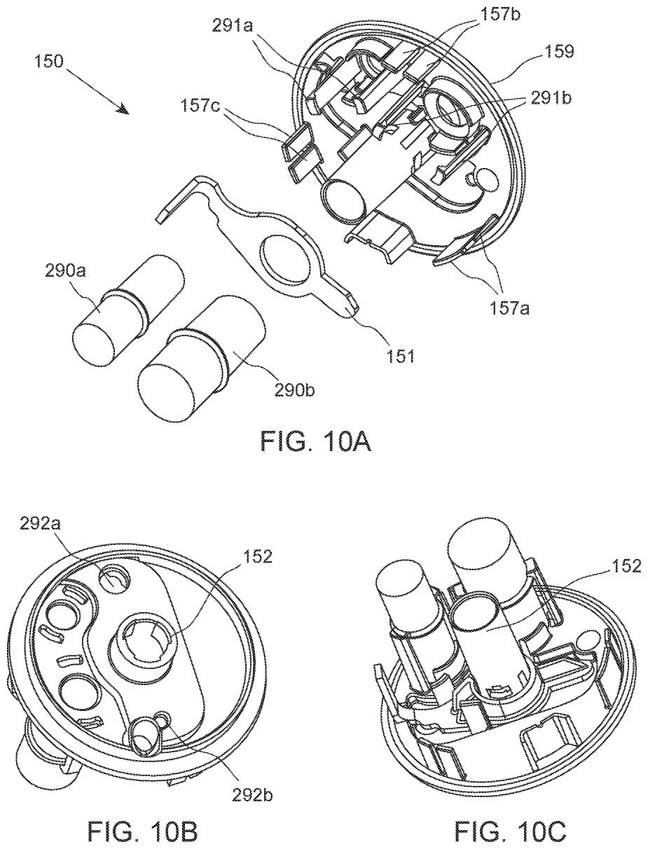

FIGS. 10A-10C show additional drawings of the sealing plate assembly. FIG. 10A is an exploded view of the sealing plate assembly 150 showing the sealing plate 159, pivotable locking arm 151, and buffer packs 290a and 290b. The snap-in features 157a-157c for immobilizing the sealing plate assembly on the cylindrical structure are depicted. Hollow shaft 152 is located in approximate center of the plate and extends downwards towards the bottom of the cylindrical structure and upwards towards the cap. Also visible are finger-like structures 291a and 291b for holding the buffer packs. A view from the top of the sealing plate assembly is shown in FIG. 10B. The hollow shaft extends above the plane of the sealing plate. The sealing plate includes two openings 292a and 292b aligned with the approximately diametrically opposite regions on upper surface of the locking arm 151 where the push rods of the cap contact the locking arm. A upside down view of the sealing plate assembly is shown in FIG. 10C.

Cap

As summarized above, in certain embodiments, the sample preparation cartridge further includes a cap slidably positioned on the top of the cylindrical structure. By slidably positioned, it is meant that the cap can be positioned on the top of the cylindrical structure in such a manner that it can slide towards the cylindrical structure.

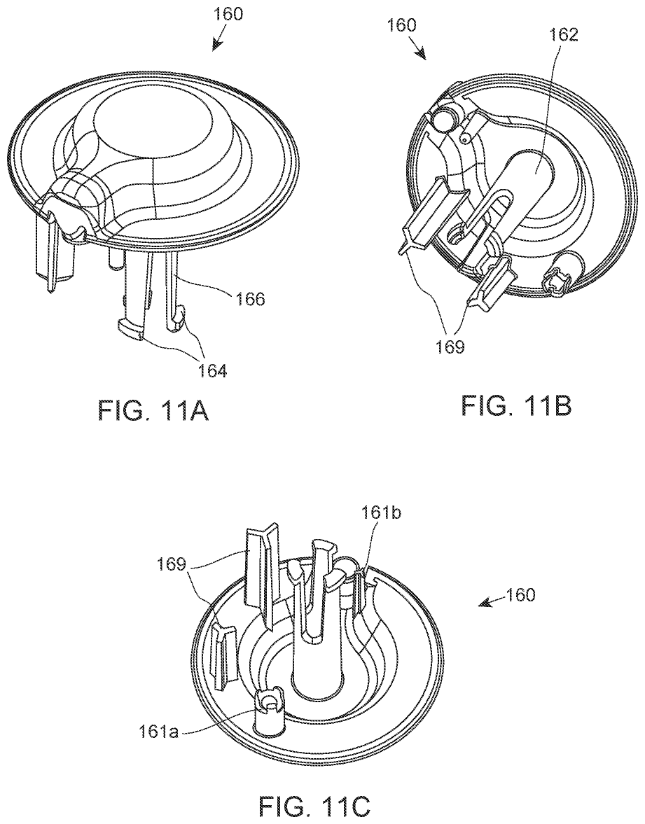

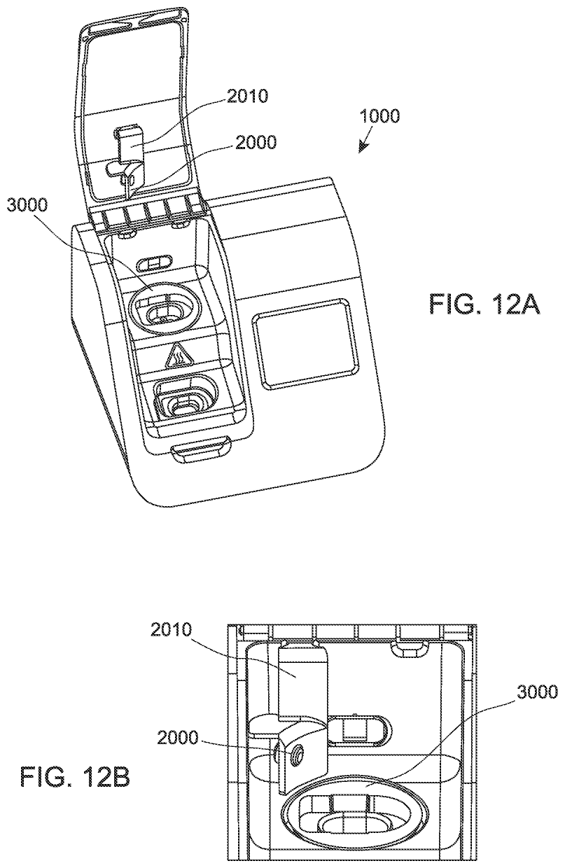

FIGS. 11A-11C show the cap 160 in isolation from different angles. FIG. 11A shows the orientation in which the cap 160 is attached to the cylindrical structure by engaging the protrusions 164 with the indents located in the interior wall of the shaft present in the sealing plate assembly which sealing plate assembly is attached to the cylindrical structure. The protrusions 164 are located at the distal end of the engagement structure 162 on finger-like extensions 166 that can expand out in absence of pressure and can be squeezed together when slid inside the shaft of the sealing plate assembly and can expand out again once slid through the shaft such that the protrusions are located under the distal end of the shaft (see FIGS. 6D and 7D). While the cap is depicted with a central dome, other configurations are also within the scope of the invention. For example, in certain embodiments, the cap may be substantially flat, and the length of the engagement structure decreased accordingly for proper fit inside the shaft of the sealing plate and inside the cylindrical structure. Push rods 161a and 161b that extend from a lower surface of the cap are visible in FIGS. 11B and 11C. Additional features that may be included in the cap but are not necessary for the system for transferring liquid from a chamber into collection containers include plungers 169. In embodiments, where the sealing plate assembly includes a buffer pack, e.g., a lysis buffer pack and an elution buffer pack, the plungers may be used to release the buffers from the buffer pack wells. For example, pressing the cap down into close contact with the sealing plate assembly may simultaneously release the buffers and arm the system for triggering a negative pressure in the plunger chamber.

Exemplary sample preparation devices that can include the system for transporting an elution buffer comprising a target analyte into one or more collection containers for analysis of the target analyte are described in greater detail in PCT Application No. PCT/US2020/066926 filed on Dec. 23, 2020 which is herein incorporated by reference in its entirety. Specific examples of a buffer pack and a cap and associated systems for actuation of buffer pack for delivery of buffer to one or more chambers of a sample preparation device are provided in an U.S. Provisional Patent Application titled “Magnetic Particle Separation Device Buffer Pack and Cap Design,” Attorney Docket No. ADDV-082PRV, co-filed with this application, which application is herein incorporated by reference in its entirety.

### Systems and Methods

Also provided herein are systems that can semi-automatically or automatically transfer a liquid from a chamber into one or two or more collection chambers. For example, the chamber may be an elution chamber comprising an elution buffer and a target analyte, e.g., nucleic acids isolated from a biological sample.

In certain embodiments, the system may include a sample preparation cartridge such as a cartridge comprising the components for transferring a liquid from a chamber of the cartridge into one or two or more collection chambers of the cartridge. The system may further include an instrument in which the cartridge is placed. For example, the instrument may be an instrument shown in FIG. 10A. The instrument may further include a removable or permanently attached magnet. The magnet may be positioned such that it is sufficiently adjacent the trigger of the assembly so it can effectively prevent the trigger from moving. The instrument may include a motor that rotates a platform in which the cylindrical cartridge is placed. The rotation of the platform rotates the cartridge while the magnetic trigger is held in place by the magnet. As explained herein, the rotation of the cartridge causes the rigid structure of the plunger mechanism to slide relative to the locking arm. Once the rigid structure slides away from the locking arm, it moves upward with a force stored in the compressed spring, thereby creating a negative pressure in the plunger chamber.

An exemplary method for using the system for transferring a liquid from a chamber of the cartridge into one or two or more collection chambers of the cartridge is now described. A cartridge with the cap positioned in pre-activation stage is placed in the rotatable platform of an instrument. An exemplary cartridge is depicted in FIG. 5A. An exemplary instrument with a rotatable platform that engages with the cartridge is depicted in FIGS. 10A and 10B. After the cartridge is placed in the instrument, the user loads a biological sample into a chamber of the cartridge. For example, a user may pipette in a sample to chamber 300. In certain embodiments, the user may also introduce a lysis buffer into the chamber 300 or may introduced a mixture of lysis buffer and sample into chamber 300. In other embodiments, the cartridge may be configured for automatically filling the chamber 300 with lysis buffer. For example, a user may press the cap downwards after loading the sample into chamber 300. As explained herein, pushing the cap downwards may cause a plunger in the cap to pierce a lysis buffer pack present in the sealing plate assembly. The lysis buffer may then flow into the lysis chamber 118. The lysis chamber or the lysis buffer or the sample may also include PMPs. The platform 3000 of the instrument may rotate the cartridge back and forth to facilitate lysis of cells/viruses and release of the target analyte, e.g., nucleic acid. The PMPs are functionalized to bind to and immobilize the target analyte. The instrument may stop the back-and-forth rotation of the cartridge and rotate the cartridge such that the chamber 118 is adjacent the magnet 2000 present in the instrument 1000. The magnet 2000 is depicted as a removable magnet. The magnet is housed in a support structure that includes means for removably immobilizing the magnet in the instrument. Such mean can include a snap-in feature that is sized to fit inside or outside a corresponding feature in the instrument. The magnet aggregates the PMPs. The magnet is positioned such that the aggregate is formed substantially at the opening of channel 220a that fluidically connects the lysis chamber 118 to the middle chamber 119. The middle chamber 119 may include a wash buffer or an immiscible phase such as oil or air. The instrument then rotates the cartridge to transport the aggregate through the channel 220a into the middle chamber 119. While not depicted in FIG. 5A, the cartridge can include additional chambers, e.g., an immiscible phase chamber followed by a wash chamber and the like. The instrument then rotates the cartridge to transport the aggregate through the channel 220b into the chamber 120. The chamber 120 may have been prefilled with an elution buffer during manufacture of the cartridge or by a user prior to or after placing the cartridge in the instrument. In certain embodiments, the chamber 120 may be filled with elution buffer when the cap is pressed down by the user. In these embodiments, the cap may include a plunger that forces the elution buffer out of the elution buffer pack in the sealing plate assembly. The elution buffer then fills the chamber 120 via an inlet connected to a channel extending between the inlet and the well in which the elution buffer pack is placed.

As explained herein, when the user places the cartridge with the cap in the pre-activation stage in a sample processing instrument, the push rods 161a and 161b do not apply downward pressure on the pivotable locking arm 151. The trigger 170 is located at a relatively higher position with respect to the bottom of the cylindrical cartridge. At this height, the trigger is not engageable by the magnet 2000 in the instrument 1000. When the user presses the cap down, the push rods 161a and 161b press down on the pivotable locking arm 151, forcing it to move down the shaft 152 and press down on the rigid structure 141a of the plunger assembly thereby compressing the spring 142. The compressible structure 141b also moves down causing air to expel from the plunger chamber 140. See FIGS. 6A-6D. The trigger is pushed down further, closer to the bottom of the cartridge to a height which matches the height of the magnet relative to the bottom of the cartridge. At this height the magnetic force generated by the magnet can engage the trigger. At this point, the spring is in an armed position and is storing potential energy.

Once the PMPs have been transported to the chamber 120, the nucleic acids or another target analyte are released from the PMPs into the elution buffer. The PMPs can then be aggregated by the magnet and transported backwards to either the middle chamber(s), e.g., wash chamber 119 or lysis chamber 118. In a final step, the rotatable platform rotates the cartridge such that the trigger is aligned with the magnet and then continues to rotate the cartridge. The magnetic force acting on the trigger immobilizes the end of the pivotable locking arm, causing the arm to pivot about the shaft. The relative movement of the cartridge and the locking arm causes the rigid structure 141a to slide off from under the locking arm and the plunger mechanism fires back up under momentum provided by the stored potential energy in the compressed spring, causing a vacuum in the plunger chamber (see FIGS. 7A-7D).

The vacuum creates a negative pressure in a channel extending from a drain hole 125 at the bottom of chamber 120 to inlets for collection containers 130. The negative pressure forces the liquid to drain from chamber 120 and flow into the collection containers 130. When the trigger is moved, the spring fires up, pushing the compressible structure upwards, generating the negative pressure in the system. The negative pressure creates a suction force in channel 145 and collection containers 130 which in-turn draw the fluid from chamber 120 into the channel 146. As the negative pressure draws the fluid through, it enters the two collection containers 130. Since the remaining air pressure in the collection containers 130 is equal, the fluid equally divides between the collection containers.

While the system and method of using the system utilize a magnet and a magnetically responsive trigger to create negative pressure in the plunger chamber to effect transfer of the liquid (e.g., elution buffer) from chamber 120 into collection containers 130, the trigger may be immobilized which the cartridge rotates by utilizing a physical barrier instead of a magnet. As explained herein, the trigger may project out of the cartridge and may be blocked from moving by a physical barrier.

The magnet when present, may be mounted on a housing which is disposed permanently or removably in the instrument. By magnet, it is meant any object having the ability to produce a magnetic field external to itself. For example, the magnet may produce a magnetic field capable of attracting paramagnetic particles. In some instances, the magnet may be an electromagnet. In certain embodiments, the magnet is positioned proximal to the exterior of the annular wall of the cartridge.

The rotatable platform of the instrument can be actuated using a motor. The motor can be automated thereby automating the methods of transporting a liquid from a chamber into one or more collection containers. The motor can also be controlled by a computer program, which when executed by a processor, causes the motor to perform the methods of using the system as disclosed herein.

In certain embodiments, the motor rotates the cylindrical cartridge in the increments of 1.8° angle.

In some embodiments, the motor rotates the cylindrical structure to return it to a predetermined position, for example, where the magnet is positioned proximal to the lysis chamber, immiscible phase chamber, elution chamber, or the trigger.

The motor can be configured to provide only a fraction of the full 360° rotation. For example, the motor can be configured to provide only between 60° and 120° rotation, preferably, between 80° and 110° rotation, even more preferably, between 90° and 100° rotation, and most preferably, about 90° rotation.

### Additional Functionalities Added to the Sample Preparation Device

In certain embodiments, the systems, sample preparation devices, and instruments may include additional functionalities that can monitor certain aspects of the sample preparation and/or the methods of using the devices.

For example, the sample preparation device/instrument can comprise a temperature sensor that can monitor and report the temperature of the reagents, particularly, in various chambers of the sample preparation device. The sample preparation instrument may be provided with the means for controlling the temperature, such as heaters or coolers that can provide a desired temperature in one or more chambers of the sample preparation device.

The sample preparation instrument can be fitted with a fluorometer for reading fluorescence in one or more chambers of the sample preparation cartridges. The fluorometer can be configured to provide an on-demand reading with specific parameters, preferably, without any movement caused by the motor, if present.

In further embodiments, the sample preparation instrument can be fitted with a camera for capturing images during the process of sample preparation. One or more cameras can be positioned or configured to capture images from one or more chambers of the device.

The devices disclosed herein are suitable for methods of detection of nucleic acids in a short amount of time, such as less than 20 minutes, less than 15 minutes, less than 10 minutes, or less than 5 minutes, e.g., 1 minute-5 minutes.

In some cases, the cartridges and associated instrumentation are configured so that a sample can be loaded, the cover pressed down and the rest of the processing steps are automated. Thus, the results can be obtained with minimal user mediated steps. Particularly, the user may only need to load the sample in the cartridge and load the cartridge into the instrumentation, not necessarily in that order, push down the cap and actuate the analytical instrument to analyze the sample. The instrumentation is configured to process the sample to isolate the nucleic acids from the sample; deliver the nucleic acids into the collection containers, for example, PCR tubes; conduct the analysis, such as PCR; and present the results, for example, display on a screen, provide a printout, save on a computer system, or transmit the results to a remote computer system. Thus, the cartridges disclosed herein could be used in the appropriate sample analytical instrumentation, such as Abbott's ID NOW™ instrumentation, where the only user mediated step is loading of the sample into the cartridge and loading the cartridge into the analytical instrument (not necessarily in that order) and pressing down the cap. The appropriate computer program that controls the existing sample analytical instrument can be revised to operate and process the samples from a cartridge disclosed herein.

In certain aspects, the sample is a sample of whole blood, serum, plasma, sputum, nasal fluid, saliva, mucus, semen, urine, vaginal fluid, a tissue, organ, and/or the like of a mammal (e.g., a human, a rodent (e.g., a mouse), or any other mammal of interest). In other aspects, the sample is a collection of cells from a source other than a mammal, such as bacteria, yeast, insects (e.g., Drosophila), amphibians (e.g., frogs (e.g., Xenopus)), viruses, plants, or any other non-mammalian nucleic acid sample source.

In certain aspects, rotating the cylindrical cartridge from a first position to a second position comprises rotating the cylindrical cartridge so that the entire span of the lysis chamber is rotated across the magnet. That is, the cylindrical cartridge may be rotated such that the entire lateral span of the lysis chamber is exposed to the magnet.

Similarly, in certain aspects, rotating the cylindrical cartridge from a second position to a third position comprises rotating the cylindrical cartridge so that the entire span of the immiscible phase chamber is rotated across the magnet. That is, the cylindrical cartridge may be rotated such that the entire lateral span of the immiscible phase chamber is exposed to the magnet.

The methods of the present disclosure may include the additional steps of filling the lysis chamber with a lysis buffer and paramagnetic particles from a fluid pack housed within a buffer pack and filling an elution chamber with an elution buffer from a fluid pack housed within the buffer pack. In embodiments utilizing a non-air immiscible phase, the steps may additionally include filling an immiscible phase chamber with an immiscible phase from a fluid pack housed within the buffer pack.

In certain embodiments, fluid is transferred from a fluid pack housed within a buffer pack to a chamber by applying pressure to the fluid in the fluid pack to force the fluid through channels in the cylindrical structure of the sample preparation device. For example, the fluid may comprise a lysis buffer, in some cases including paramagnetic particles, an immiscible phase and an elution buffer. In some cases, the immiscible phase comprises oil.

When fluid is transferred from a fluid pack, in certain embodiments, pressure is applied to the fluid in the fluid pack by applying mechanical force to the cap of the sample preparation device that comprises plungers to engage the fluid pack.

The cap may be configured to provide a tactile, visual, and/or auditory feedback to the user to indicate that the cap is properly located. For example, upon application of downward pressure by the user, the cap may slide down the shaft of the sealing plate assembly and produce a clicking sound to indicate that the cap is properly positioned. In other embodiments, the cap may initially slide down rapidly and not move any further in response to further downward pressure by the user, indicating that the cap is properly positioned.

Accordingly, the preceding merely illustrates the principles of the present disclosure. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

What is claimed is:

1. A system for transporting a liquid from a chamber into one or more collection containers, the system comprising:
a plunger chamber comprising a plunger assembly and a spring, wherein when armed the plunger assembly compresses the spring;
a pivotable locking arm, wherein
in a first position, the locking arm and the plunger assembly are engaged such that the locking arm depresses the plunger assembly thereby arming the spring, and
in a second position, the locking arm and the plunger assembly are disengaged allowing the plunger assembly to retract away from the spring and create a vacuum in the plunger chamber,
a trigger coupled to the pivotable locking arm, wherein the trigger when engaged by a force or a physical interference causes the locking arm and the plunger assembly to disengage,
wherein the plunger chamber is fluidically connected to a channel connecting the chamber comprising the liquid to the one or more collection containers, and
wherein the vacuum draws the liquid from the chamber comprising the liquid via the channel into the one or more collection containers.

2. The system of claim 1, wherein the system comprises two collection containers and wherein the channel bifurcates into two sub-channels fluidically connected to the two collection containers.

3. The system of claim 1 or 2, wherein the plunger chamber is substantially cylindrical in shape and wherein the plunger assembly comprises a rigid structure and a compressible structure,
wherein the rigid structure comprises a narrow-elongated region having substantially curved end and a substantially flat end opposite the curved end, wherein the curved end engages with the locking arm and the flat end is attached to the compressible structure, and
wherein the compressible structure forms a seal with the interior surface of the plunger chamber.

4. The system of any one of claims 1-3, wherein the pivotable locking arm comprises a first region pivotably attached to a shaft and a second region that engages with the plunger assembly, wherein the second region comprises a reduced area surface as compared to the first region.

5. The system of claim 4, wherein the surface area is reduced by presence of a notch in the second region.

6. The system of claim 5, wherein the second region of the locking arm comprises a first area that contacts the curved end of the plunger assembly and a second area adjacent the first area, wherein the second area includes a ramp leading to the notch.

7. The system of claim 5 or 6, wherein the notch is located on a side edge of the second region.

8. The system of claim 5 or 6, wherein the notch is located in a middle of the second region.

9. The system of any one of claims 5-8, wherein the notch comprises a substantially circular edge.

10. The system of any one of claims 5-9, wherein the second region comprises two notches, wherein the first and second notches are located on opposite side edges of the second region or wherein the first notch is located on a side edge and the second notch is located in the middle of the second region.

11. The system of any one of claims 1-10, wherein the trigger is removably coupled or fixedly coupled to the locking arm.

12. The system of any one of claims 1-11, wherein the trigger is coupled to a portion of the arm that extends downwards from the locking arm.

13. The system of any one of claims 1-12, wherein the trigger comprises a magnetically responsive material.

14. The system of claim 13, wherein magnetically responsive material comprises iron, nickel, cobalt, oxides thereof, derivatives thereof, and combinations thereof.

15. The system of any one of claims 4-14, further comprising an actuation assembly for placing the pivotable locking arm in the first position to arm the plunger assembly, the actuation assembly comprising:
a cap comprising a first surface opposite a second surface, a plurality of push rods extending from the second surface,
wherein the first region of the pivotable locking arm comprises an opening through which the arm is pivotally attached to the shaft and comprises a lip region surrounding the opening, the lip region configured to provide a surface area engageable by the push rods at two contact points located substantially diametrically opposite to each other.

16. The system of any one of claims 4-15, wherein the system comprises a sealing plate assembly comprising a substantially planar region comprising an upper surface opposite a lower surface, wherein the shaft is centrally located in the sealing plate assembly and extends above and below the plane of the sealing plate assembly and wherein the locking arm is pivotably and slidably positioned on the shaft, wherein the locking arm is disposed adjacent the lower surface of the sealing plate assembly prior to being engaged by the push rods at the two contact points, wherein upon engagement with the push rods, the locking arm is configured to slide down the shaft, away from the lower surface.

17. The system of claim 16, wherein the shaft comprises a large effective diameter at a region adjacent the lower surface as compared to a region further away from the lower surface such that the pivotable arm pivots more freely around the shaft when the locking arm is pushed away from the lower position adjacent the lower surface.

18. The system of claim 16 or 17, wherein the sealing plate assembly comprises two through-apertures located on diametrically opposite sides of the shaft, wherein the apertures are aligned with the contact points on the locking arm and the push rods such that the push rods pass through the apertures to contact the locking arm.

19. The system of any one of claims 15-18, wherein the shaft is hollow and comprises indents located in the interior surface, wherein the cap comprises a centrally located engagement structure extending from the second surface of the cap, the engagement structure comprising protrusions that reversibly fit into the indents, wherein when the protrusions are positioned in the indents, the push rods do not apply downward pressure on the locking arm.

20. The system of claim 19, wherein the engagement structure comprises a rod shaped structure comprising a plurality of fingers extending from a distal end of the rod-shaped structure, wherein the protrusions are located at a distal end of the plurality of fingers and wherein the shaft in the sealing plate assembly comprises a diameter larger than the diameter of the engagement structure and wherein the shaft comprises a lip at a distal end and wherein upon application of downward pressure on the cap, the protrusions disengage from the indents allowing the engagement structure to slide down the shaft such that the protrusions are located under the lip and the cap cannot be retracted.

21. The system of any one of claims 16-20, comprising a cylindrical cartridge comprising a top end and a bottom end and an annular wall extending between the top and bottom ends, wherein the cylindrical cartridge comprises the chamber, plunger chamber, pivotable locking arm, trigger, sealing plate assembly and cap, and wherein the sealing plate assembly is fixedly positioned over the top end of the cylindrical cartridge and wherein upon application of downward force on the cap, the cap is fixedly positioned over the sealing plate assembly.

22. The system of any one of claims 16-21, wherein the trigger comprises a magnetic material, the system further comprising a magnet positioned adjacent the outer surface of the annular wall, wherein the cylindrical cartridge is rotatable to a position that places the trigger adjacent the magnet, wherein magnetic force from the magnet holds the locking arm in place while the cylindrical cartridge rotates causing the locking arm to disengage from the plunger assembly.

23. The system of any one of claims 16-21, wherein the trigger comprises a non-magnetic material, the system further comprising a pillar shaped structure positioned adjacent the outer surface of the annular wall, wherein the cylindrical cartridge is rotatable to a position that places the trigger adjacent the pillar shaped structure, wherein the trigger comprises a protruding region extending from inside the cylindrical structure to outside of the annular wall and wherein the pillar shaped structure provides the physical interference that engages the trigger causing the locking arm to disengage from the plunger assembly upon rotation of the cylindrical cartridge.

24. The system of any one of claims 1-23, wherein the spring is positioned in an interior region of the plunger chamber.

25. The system of any one of claims 1-23, wherein the spring is positioned around an exterior of the plunger chamber.

26. The system of claim 25, wherein the plunger assembly comprises a rigid structure and a compressible structure,
wherein the rigid structure comprises an outer region positioned around an outer region of the plunger chamber and enclosing the top end of the plunger chamber, the outer region comprising an engagement structure extending away from the outer region,
wherein the engagement structure is sized to slidably fit inside a cut-out in the pivotable locking arm,
wherein the rigid structure comprises an inner region positioned in the interior of the plunger chamber and fixedly attached to the compressible structure,
wherein the compressible structure is positioned in a bottom region of the plunger chamber when the pivotable locking arm and the engagement structure are engaged and retracts away from the bottom region of the plunger chamber when the engagement structure is released from the pivotable locking arm.

27. The system of claim 26, wherein the trigger comprises a shaft region rotatably engaged with a metallic ball, wherein the metallic ball is movable towards the plunger chamber upon application of magnetic force, wherein upon movement of the metallic ball towards the plunger chamber, the pivotable locking arm rotates leading to release of the engagement feature of the outer region of the rigid structure of the plunger assembly.

28. The system of claim 27, wherein the trigger and the pivotable locking arm are configured as a single structure and the pivotable locking arm is held in a groove that structurally supports the arm while allowing rotation of the arm.

29. The system of any one of claims 26-28, further comprising an actuation assembly for placing the pivotable locking arm in the first position to arm the plunger assembly, the actuation assembly comprising:
a cap comprising a first surface opposite a second surface, a plurality of push rods extending from the second surface,
wherein the plurality of push rods engage with the plunger assembly and force downward movement of the rigid structure upon application of downward pressure on the cap and
wherein the downward movement of the rigid structure results in locking of the engagement structure of the rigid structure into cut-out of the pivotable locking arm and arming of the plunger assembly.

30. The system of any one of claims 1-29, wherein the system is semi-automatic.

31. The system of any one of claims 1-29, wherein the system is automatic.

32. A method for transporting a liquid from a chamber into one or more collection containers, the method comprising:
providing a system according to any one of claims 1-31;
moving the pivotable locking arm to the first position, wherein the locking arm engages with the plunger assembly to arm the plunger assembly thereby compressing the spring;
allowing for the chamber to automatically fill with the liquid; and
engaging the trigger thereby disengaging the pivotable locking arm from the plunger assembly, allowing the plunger assembly to retract away from the spring and create a vacuum in the plunger chamber,
wherein the vacuum draws the liquid from the chamber via the channel into the one or more collection containers.

33. The method of claim 32, wherein the system comprises the cylindrical cartridge according to claim 21 and wherein providing the system comprises providing the cylindrical cartridge wherein the sealing plate assembly is fixedly positioned over the top end of the cylindrical cartridge and the cap is positioned such that the protrusions are positioned in the indents, the push rods are not in contact with the locking arm.

34. The method of claim 33, wherein moving the pivotable locking arm to the first position comprises applying downward pressure on the cap such that the protrusions disengage from the indents allowing the engagement structure to slide down the shaft such that the protrusions are located under the lip and the cap cannot be retracted and wherein the push rods push the locking arm away from the lower position adjacent the lower surface of the of the sealing plate assembly.

35. The method of claim 32, wherein the system comprises the cylindrical cartridge according to any one of claims 25-31 and wherein providing the system comprises providing the cylindrical cartridge wherein the sealing plate assembly is fixedly positioned over the top end of the cylindrical cartridge and the cap is positioned over the sealing plate and vertically aligned with the sealing plate and the push rods are not in contact with the plunger assembly.

36. The method of any one of claims 31-35, wherein applying downward pressure on the cap comprises manually pressing down the cap.

37. The method of any one of claims 31-36, wherein allowing the chamber to automatically fill with the liquid comprises placing the system in association with an instrument that processes a biological sample to isolate a target analyte, if present, and provide the target analyte in the liquid in the chamber.

38. The method of any one of claims 31-37, wherein engaging the trigger comprises physically contacting the trigger thereby disengaging the pivotable locking arm from the plunger assembly.

39. The method of any one of claims 31-37, wherein engaging the trigger comprises placing the trigger adjacent the magnet, wherein magnetic force from the magnet holds the locking arm in place while the cylindrical cartridge rotates causing the locking arm and the plunger assembly to disengage.

40. The method of any one of claims 31-37, wherein engaging the trigger comprises placing the trigger adjacent the magnet, wherein magnetic force from the magnet moves the locking arm while the cylindrical cartridge remains stationary causing the locking arm to move to the second position.
